(19) United States
(12) Patent Application Publication
(10) Pub. No.: US 2008/0306754 A1
(43) Pub. Date: Dec. 11, 2008

(54) Pet commerce and pet groups in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/811,388

(22) Filed: Jun. 8, 2007

(51) Int. Cl. G06Q 99/00

(52) U.S. Cl. 705/1

(57) ABSTRACT

A method, apparatus, and system of pet commerce and pet groups in a geo-spatial environment are disclosed. In one embodiment, a method includes generating a community network of user profiles, each user profile associated with a specific geographic location, procuring preseeded pet data, providing categories of the preseeded pet data, automatically generating, within the community network, groups of user profiles, each group of user profiles based on at least one category of the preseeded pet data, and generating a display view to include a three-dimensional map view embodied by the community network, a first group of user profiles, each user profile of the first group represented at a location in the three-dimensional map view corresponding to the specific geographic location with which each user profile is associated.

### FIELD OF TECHNOLOGY

This disclosure relates generally to the technical fields of communications and, in one example embodiment, to a method, apparatus, and system of pet commerce and pet groups in a geo-spatial environment.

### BACKGROUND

Pets are popular, and many people love their pets. People spend money on their pets. Neighbors often have similar interests in pets and often have similar types of pets. It may be difficult, however, to determine which neighbors have similar interests. It may be difficult to determine which neighbors have similar pets. Further, it may be difficult to locate products and services for the pets. It may be difficult to determine how to procure the products and the services at favorable prices. It may be difficult to determine when providers of the products and the services offer periodic discounts and incentives associated with the products and the services.

Conversely, it may be difficult for the providers of the products and the services to determine which households have pets and to effectively market their products and the services.

### SUMMARY

A method, apparatus and system of pet commerce and pet groups in a geo-spatial environment are disclosed. In one aspect, a method includes generating a community network of user profiles, each user profile associated with a specific geographic location, procuring preseeded pet data, providing categories of the preseeded pet data (e.g., the categories of the preseeded pet data may include a user name, a geographic region, a pet name, a type of pet, at least one of a product and/or a service), automatically generating, within the community network, groups of user profiles, each group of user profiles based on at least one category of the preseeded pet data, and generating a display view to include a three-dimensional map view embodied by the community network, a first group of user profiles, each user profile of the first group represented at a location in the three-dimensional map view corresponding to the specific geographic location with which each user profile is associated.

In addition, the method may include generating pet profiles based on the preseeded pet data, each pet profile associated with a user profile. The method may also include determining a first geographic region, selecting at least one other category of the preseeded pet data, identifying a first set of user profiles matching the first geographic region and the other category, identifying the pet profiles associated with the first set of user profiles, and automatically generating, in the display view, the first set of user profiles and the pet profiles associated with the first set of user profiles.

Furthermore, the method may include selecting the first geographic region from a group comprising a neighborhood associated with a street address, a city, a county, a state, and/or a country. The method may also include selecting at least one type of pet, identifying user profiles associated with the type of pet, and enabling formation of a pet club group based on the user profiles associated with the type of pet. In addition, the method may include generating a pet club group communication (e.g., the pet club group communication may include an invitation, a webpage, a newsletter, and/or a member directory) associated with the pet club group via a communication mode.

The method may further include selecting the communication mode from a group comprising an online communication mode and/or a physical communication mode. The method may also include scheduling a meeting of the pet club group. In addition, the method may include generating meeting notifications based on the user profiles associated with the type of pet. The method may also include selecting at least one of the product and/or the service, identifying user profiles associated with the product and/or the service, and forming a buyers club group based on the user profiles associated with the product and/or the service.

Furthermore, the method may include generating a transaction based on the product and/or the service. The method may also include generating a request for bids, generating an online order for a bulk quantity of the product and/or the service, and/or generating an online payment transaction associated with the online order.

The method may also include determining a second geographic region, identifying a second set of user profiles having a specific geographic location associated with the second geographic region and at least one associated pet profile, and generating a consumer communication via a communication mode to each user in the second set of user profiles. Furthermore, the method may include selecting at least one of a type of pet (e.g., the type of pet may be selected from a group consisting of dogs, cats, birds, horses, farm animals, exotic pets, reptiles, small animals, and/or fish, etc.) and at least one of the product and/or the service (e.g., the product and/or the service may be selected from a group consisting of a food, a grooming product, a health product, a grooming service, an exercising service, a boarding service, and/or a care service, etc.) and generating the consumer communication (e.g., may be selected from a group comprising a marketing brochure, a flyer, a coupon, and/or a frequent shopper offer, etc.) via the communication mode to each user in the second set of user profiles associated with the type of pet and the product and/or the service.

In addition, the method may include selecting the communication mode from a group consisting of the online communication mode and/or the physical communication mode. The method may further include determining a third geographic region, identifying the buyers club group associated with the third geographic region, and generating a bid transaction associated with the product and/or the service sought by the buyers club group.

In addition, the method may include submitting a bid associated with the product and/or the service. The method may also include placing a zero bid associated with the product and/or the service, determining a reserve price associated with the product and/or the service and/or bidding up a price associated with the product and/or the service. In addition, the method may include bidding down the price associated with the product and/or the service, accepting a submitted bid, generating an online order for the at least one of the product and/or the service, and generating an online payment transaction associated with the online order.

Moreover, the method may include simultaneously generating, in the three-dimension map view, wiki profiles associated with specific geographic locations. The method may also include generating content associated with the wiki profiles.

In another aspect, a system includes a geo-spatial environment, a data procurement module of the geo-spatial environment to procure preseeded pet data (e.g., the preseeded pet data may be procured from a public source), a category module of the geo-spatial environment to provide categories of the preseeded pet data, a community network module of the geo-spatial environment, to include user profiles, each user profile associated with a specific geographic location and at least a portion of the preseeded pet data, and pet profiles, each pet profile associated with a user profile and the portion of the preseeded pet data, a map module of the geo-spatial environment to include map data of the specific geographic locations associated with each user profile, a group module of the geo-spatial environment to generate groups of user profiles, each group based on at least one category of the preseeded pet data, a display module of the geo-spatial environment to generate a display view of a three-dimensional map view embodied by a community network, at least a portion of the user profiles represented at locations in the three-dimensional map view corresponding with the specific geographic locations of the portion of the user profiles and the pet profiles associated with the portion of the user profiles, and a communication module of the geo-spatial environment to generate a communication associated with at least one user profile.

In addition, the system may include a visualization module of the geo-spatial environment to determine a geographic region (e.g., the geographic region may be selected from a group consisting of a neighborhood associated with a street address, a city, a county, a state, and/or a country), to select at least one other category of the preseeded pet data, and to automatically generate, in the display view, a group of user profiles wherein each specific geographic location of each user profile is associated with the geographic region of the geographic regions and the other category of the preseeded pet data is associated with each user profile of the group of user profiles.

The system may also include a group formation module of the geo-spatial environment to enable formation of a group based on user profiles associated with at least one category (e.g., the at least one category may include a type of pet and/or at least one of a product and/or a service) of the preseeded pet data. Furthermore, the system may include a pet club module of the geo-spatial environment to enable formation of a pet club group associated with at least one type of pet. The system may further include a meeting module of the geo-spatial environment to schedule meetings associated with the pet club group and/or to generate meeting notifications associated with the meetings.

In addition, the system may include a buyers club group module of the geo-spatial environment to enable formation of a buyers club group based on at least one of the product and/or the service. The system may also include a buyer transaction module of the geo-spatial environment to generate a business transaction (e.g., the business transaction may include a bulk purchase transaction (e.g., the bulk purchase transaction may include an online purchase transaction) of the product and/or the service) associated with the buyers group.

Moreover, the system may include a business module of the geo-spatial environment to enable formation of a business group based on one category of the preseeded pet data and/or at least one buyers club group. The system may also include a marketing module of the geo-spatial environment to generate a consumer communication (e.g., the consumer communication may be selected from a group consisting of a marketing brochure, a flyer, a coupon, and/or a frequent shopper offer) via a communication mode (e.g., the communication mode may be selected from a group consisting of an online communication mode and/or a physical communication mode) to each user profile in a group of user profiles.

The system may also include a bidding module of the geo-spatial environment to identify a buyers club group and/or to generate a bid transaction (e.g., the bid transaction may be selected from a group consisting of a bid transaction to bid up, a bid transaction to bid down, a bid transaction to place a zero bid, a bid transaction to set a reserve price, a bid transaction to generate a request for bid, and/or a bid transaction to accept a submitted bid) associated with at least one of the product and/or the service.

The system may further include a wiki profile module of the geo-spatial environment to generate a wiki profile associated with at least one representation of a user profile. Moreover, the system may include an append module of the geo-spatial environment to generate, with the wiki profile, content associated with the wiki profile. The system may also include a search module to generate a search associated with at least one of the user profiles and/or the pet profiles based on at least one category of the preseeded pet data.

In yet another aspect, a geo-spatial environment includes a first instruction set to enable a community network, to include a map database associated with map data, a user database associated with user profiles, each user profile associated with a specific geographic location identifiable in the map data, and a pet database associated with preseeded pet data and pet profiles, each pet profile associated with a user profile, a second instruction set integrated with the first instruction set to generate groups of user profiles, each group based on at least one category of the preseeded pet data, and a third instruction set integrated with the first instruction and the second instruction set to display a three-dimensional map view, embodied by the community network, to include representations of a first group (e.g., each representation of a user profile of the first group may be displayed at a location in the three-dimensional map view corresponding to the specific geographic location associated with the user profile) of the user profiles and the pet profiles associated with the first group.

In addition, the geo-spatial environment may include a fourth instruction set to display, in the three-dimensional map view, a representation of a pet club group of user profiles based on a type of pet. The geo-spatial environment may also include a fifth instruction set to display in the three-dimensional map view, a representation of a buyers club group of user profiles associated with at least one of a product and/or a service. In addition, the geo-spatial environment may also include a sixth instruction set to display in the three-dimensional map view, a representation of a business group associated with the product and/or the service.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of pet profiles associated with user profiles, according to one embodiment.

FIG. 5 is a classification view of the categories of preseeded pet data of FIG. 4, according to one embodiment.

FIG. 6 is a user interface view of searching for a pet profile based on the search query, according to one embodiment.

FIG. 7 is a user interface view of searching for matching pets based on a threshold radius in a geographic location, according to one embodiment.

FIG. 8 is a user interface view displaying information of the pet profiles of FIG. 2, according to one embodiment.

FIG. 9 is a user interface view displaying the types of pets represented in the three dimensional map view, according to one embodiment.

FIG. 10 is a user interface view displaying a list of types of pets, according to one embodiment.

FIG. 11 is a user interface view displaying pet-related product and services, according to one embodiment.

FIG. 12 is a user interface view of forming a pet club group, according to one embodiment.

FIG. 13 is a user interface view of the buyers club group module of FIG. 3, according to one embodiment.

FIG. 14 is a user interface view of a buyers club displaying bid transactions associated with a pet-related product and a service, according to one embodiment.

FIG. 15 is a user interface view of making online payments related to pet products and/or services, according to one embodiment.

FIG. 16 is a user interface view of the business module of FIG. 3, according to one embodiment.

FIG. 17 is a user interface view of the business module of FIG. 3 illustrating various communication modes, according to one embodiment.

FIG. 18 is a user interface view of generating mailing(s), according to one embodiment.

FIG. 19 is a user interface view of placing a bid, according to one embodiment.

FIG. 20 is a user interface view of communication associated with the pet club groups and consumers, according to one embodiment.

FIG. 21 is a table view of information associated with a pet-related products and/or services information associated with user profiles, according to one embodiment.

FIG. 22 is a diagrammatic system view of a data processing system in which any of the embodiments disclosed herein may be performed, according to one embodiment.

FIG. 23A is a process flow of forming a community network based on preseeded pet data, according to one embodiment.

FIG. 23B is a continuation of the process flow of FIG. 23A illustrating additional processes, according to one embodiment.

FIG. 23C is a continuation of the process flow of FIG. 23B illustrating additional processes, according to one embodiment.

FIG. 23D is a continuation of the process flow of FIG. 23C illustrating additional processes, according to one embodiment.

FIG. 23E is a continuation of the process flow of FIG. 23D illustrating additional processes, according to one embodiment.

FIG. 23F is a continuation of the process flow of FIG. 23E illustrating additional processes, according to one embodiment.

Other features of the present embodiments will be apparent from the accompanying drawings and from the detailed description that follows.

### DETAILED DESCRIPTION

A method, apparatus and system of pet commerce and pet groups in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

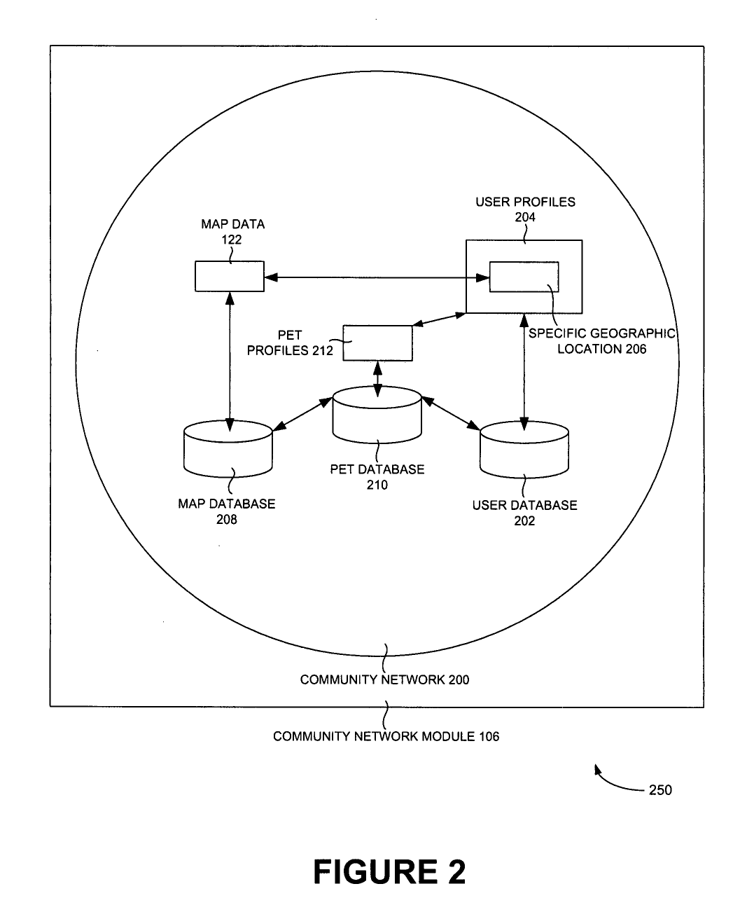

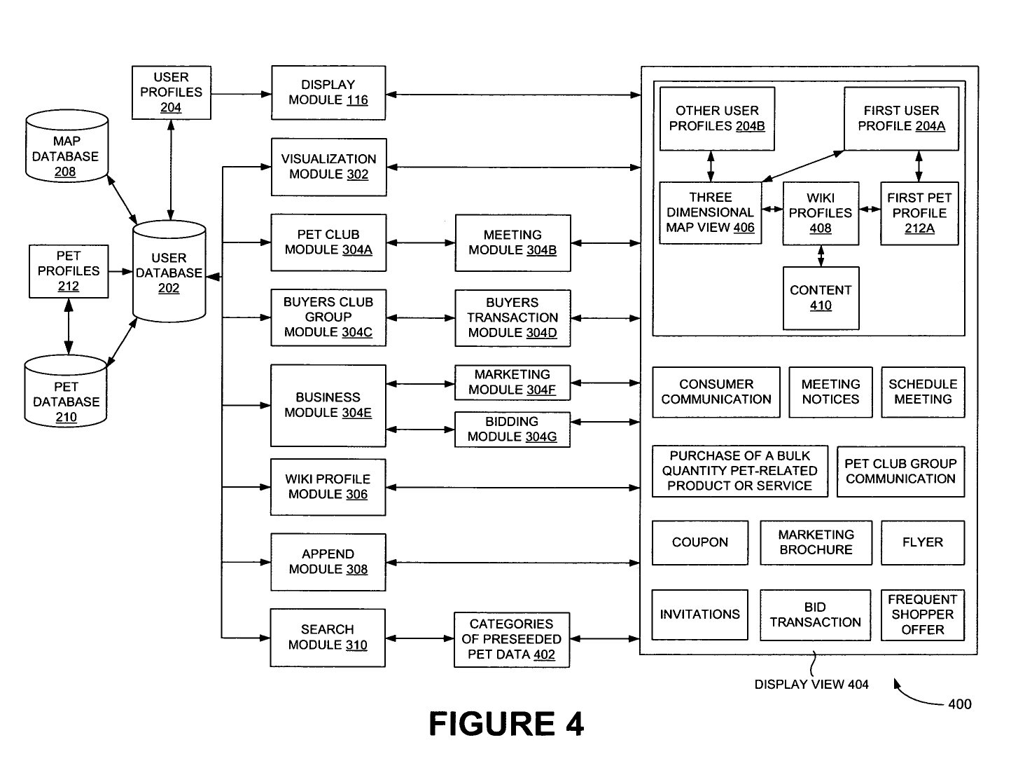

In one embodiment, a method includes generating a community network (e.g., the community network 200 of FIG. 2) of user profiles (e.g., the user profiles 204 of FIG. 2), each user profile associated with a specific geographic location (e.g., the specific geographic location 206 of FIG. 2), procuring preseeded pet data, providing categories of the preseeded pet data (e.g., the categories of preseeded pet data 402 of FIG. 4), automatically generating, within the community network 200, groups of user profiles 204, each group of user profiles 204 based on at least one category of the preseeded pet data 402, and generating a display view to include a three-dimensional map view (e.g., the three-dimensional map view 406 of FIG. 4) embodied by the community network 200, a first group of user profiles 204, each user profile of the first group represented at a location in the three-dimensional map view 406 corresponding to the specific geographic location 206 with which each user profile 204 is associated.

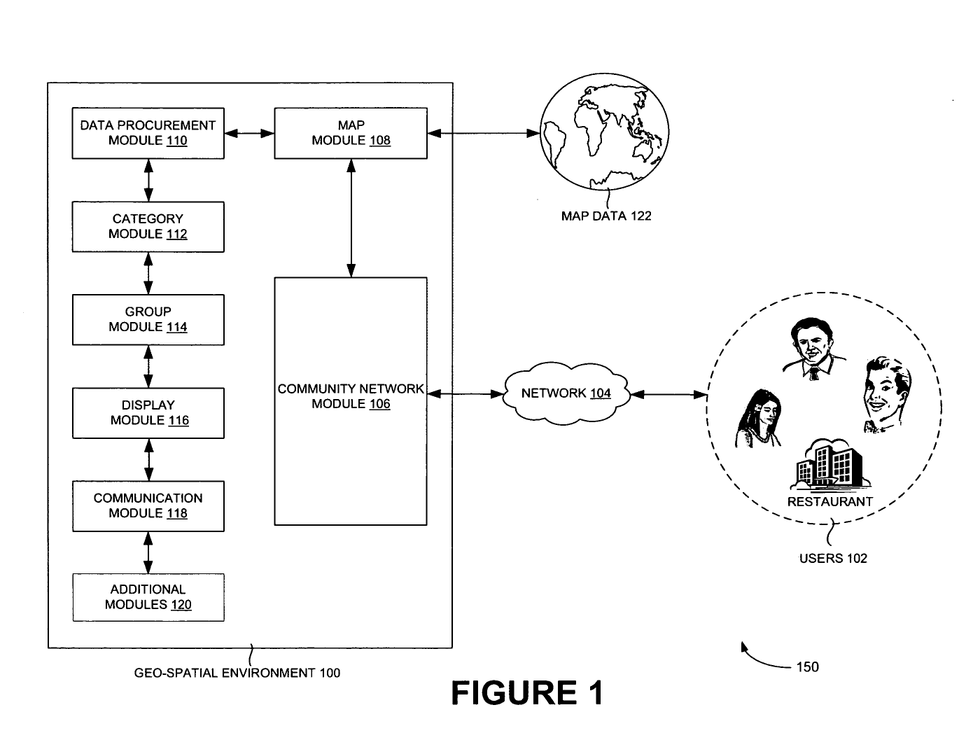

In another embodiment, a system includes a geo-spatial environment (e.g., the geo-spatial environment 100 of FIG. 1), a data procurement module (e.g., the data procurement module 110 of FIG. 1) of the geo-spatial environment 100 to procure preseeded pet data, a category module (e.g., the category module 112 of FIG. 1) of the geo-spatial environment 100 to provide categories of the preseeded pet data (e.g., the categories of preseeded pet data 402 of FIG. 4), a community network module (e.g., the community network module 106 of FIG. 1) of the geo-spatial environment 100, to include user profiles 204, each user profile 204 associated with a specific geographic location (e.g., the specific geographic location 206 of FIG. 2) and at least a portion of the preseeded pet data, and pet profiles (e.g., the pet profiles 212 of FIG. 2), each pet profile 212 associated with a user profile 204 and portion of the preseeded pet data, a map module (e.g., the map module 108 of FIG. 1) of the geo-spatial environment 100 to include map data (e.g., the map data 122 of FIG. 1) of the specific geographic location 206 associated with each user profile 204, a group module (e.g., the group module 114 of FIG. 1) of the geo-spatial environment 100 to generate groups of user profiles 204, each group based on at least one category of the preseeded pet data (e.g., the categories of preseeded pet data 402 of FIG. 4), a display module (e.g., the display module 116 of FIG. 1) of the geo-spatial environment 100 to generate a display view (e.g., the display view 404 of FIG. 4) of a three-dimensional map view (e.g., the three-dimensional map view 406 of FIG. 4) embodied by a community network (e.g., the community network 200 of FIG. 2), at least a portion of the user profiles 204 represented at locations in the three-dimensional map view 406 corresponding with the specific geographic locations 206 of the portion of the user profiles 204 and the pet profiles 212 associated with the portion of the user profiles 204, and a communication module (e.g., the communication module 118 of FIG. 1) of the geo-spatial environment 100 to generate a communication associated with at least one user profile 204.

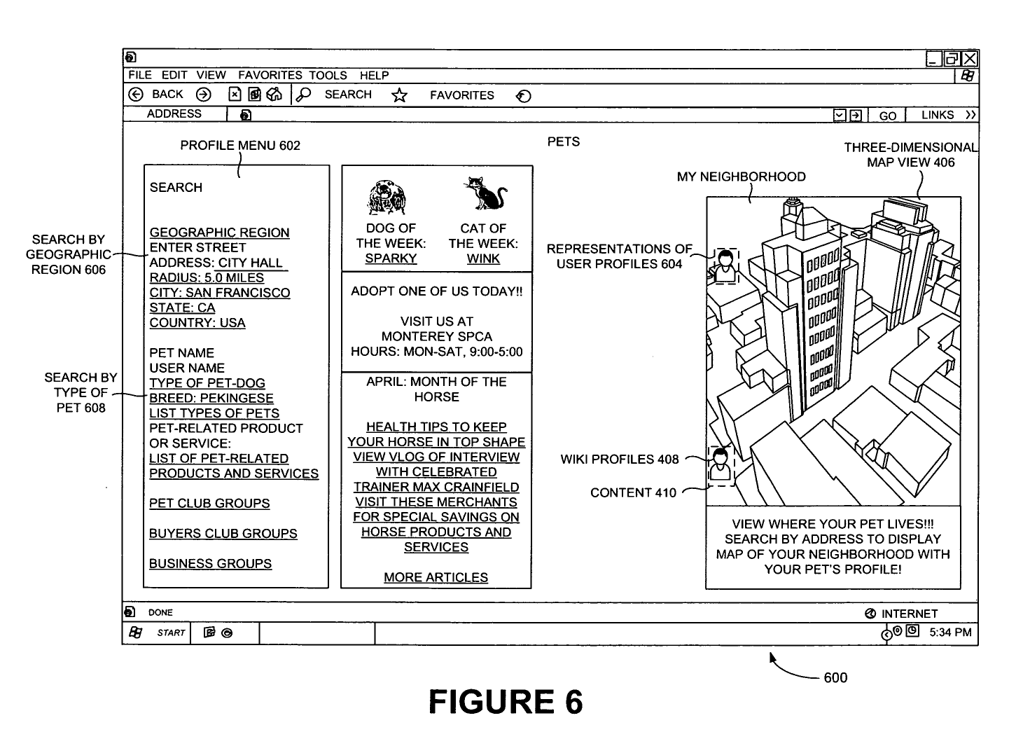

In yet another embodiment, a geo-spatial environment (e.g., the geo-spatial environment 100 of FIG. 1) includes a first instruction set to enable a community network (e.g., the community network 200 of FIG. 2), to include a map database (e.g., the map database 208 of FIG. 2) associated with map data (e.g., the map data 122 of FIG. 1), a user database (e.g., the user database 202 of FIG. 2) associated with user profiles (e.g., the user profiles 204 of FIG. 2), each user profile 204 associated with a specific geographic location 206 identifiable in the map data 122, and a pet database (e.g., the pet database 210 of FIG. 2) associated with preseeded pet data and pet profiles (e.g., the pet profiles 212 of FIG. 2), each pet profile 212 associated with the user profile 204, a second instruction set integrated with the first instruction set to generate groups of user profiles 204, each group based on at least one category of the preseeded pet data (e.g., the categories of preseeded pet data 402 of FIG. 4), and a third instruction set integrated with the first instruction and the second instruction set to display a three-dimensional map view (e.g., the three-dimensional map view 406 of FIG. 4), embodied by the community network 200, to include representations of a first group of the user profiles 204 and the pet profiles 212 associated with the first group, wherein each representation of a user profile (e.g., the representations of user profiles 604 of FIG. 6) of the first group is displayed at a location in the three-dimensional map view 406 corresponding to the specific geographic location 206 associated with the user profile 204.

FIG. 1 is a system view 150 of geo-spatial environment 100 communicating with users 102 through a network 104, according to one embodiment. Particularly, FIG. 1 illustrates the users 102, the network 104, a community network module 106, a map module 108, a data procurement module 110, a category module 112, a group module 114, display module 116, a communication module 118, additional modules 120, and map data 122, according to one embodiment.

The geo-spatial environment 100 may enable the users 102 to procure preseeded pet data to form groups of user profiles (e.g., the user profiles 204 of FIG. 2) based on categories of the preseeded pet data (e.g., the categories of preseeded pet data 402 of FIG. 4). The users 102 may be registered and/or unregistered users communicating with each other. The network 104 may enable communication between the users 102 and the geo-spatial environment 100. The community network module 106 may include the user profiles 204, each user profile is associated with a specific geographic location (e.g., the specific geographic location 206 of FIG. 2) and a portion of the preseeded pet data, each pet profile (e.g., the pet profiles 212 of FIG. 2) associated with a user profile 204 and the portion of the preseeded pet data.

The map module 108 may include map data 122 of the specific geographic location 206 associated with each user profile (e.g., the user profiles 204 of FIG. 2) which serve as a basis to render a three-dimensional map view (e.g., the three-dimensional map view 406 of FIG. 4) in the geo-spatial environment 100. The data procurement module 110 may procure preseeded pet data (e.g. the preseeded pet data may be procured from a public source) in the geo-spatial environment 100. The category module 112 may provide categories of the preseeded pet data 402 (e.g., the categories of the preseeded data may include geographic region, pet name, user name, type of pet, and/or pet related products and/or services). The group module 114 may generate groups of user profiles 204, each group based on a category of the preseeded pet data 402.

The display module 116 may generate a display view (e.g., the display view 404 of FIG. 4) of the three-dimensional map view 406 embodied by a community network (e.g., the community network 200 of FIG. 2). The communication module 118 may generate communications associated with the user profile (e.g., the user profiles 204 of FIG. 2). The additional modules 120 may generate additional processes to enable the communications in the geo-spatial environment 100. The map data 122 may contain details of maps of any region, area and/or neighborhood in the geo-spatial environment 100 which serves as a basis to identify residences, businesses, and/or civic structures having specific geographic locations (e.g., the specific geographic location 206 of FIG. 2) in the three-dimensional map view 406.

In the example embodiment illustrated in FIG. 1, the users 102 communicate with the geo-spatial environment 100 through the network 104. The geo-spatial environment 100 consists of the community network module 106, the map module 108, the data procurement module 110, the category module 112, the group module 114, the display module 116, the communication module 118, and the additional modules 120 communicating with each other. In addition, the map module 108 communicates with the map data 122.

The geo-spatial environment 100 may include the data procurement module 110 to procure preseeded pet data. (e.g., the preseeded data may be procured from a public source). The category module 112 of the geo-spatial environment 100 may provide categories of the preseeded pet data 402 (e.g., the categories of the preseeded pet data may include user name, geographic region, pet name, type of pet, at least one of product and/or service.).

The community network module 106 of the geo-spatial environment 100 may include user profiles 204. Each user profile 204 may be associated with a specific geographic location (e.g., the specific geographic location 206 of FIG. 2) and at least a portion of the preseeded pet data, and the pet profiles 212 (e.g., each pet profile 212 may be associated with a user profile 204 and the portion of the preseeded pet data). The map module 108 of the geo-spatial environment 100 may include the map data 122 of the specific geographic location 206 associated with each user profile 204.

The group module 114 of the geo-spatial environment 100 may generate the groups of user profiles 204, each group based on at least one category of the preseeded pet data 402. The display module 116 of the geo-spatial environment 100 may generate the display view 404 of the three-dimensional map view 406 embodied by the community network 200. A portion of the user profiles 204 may be represented at locations in the three-dimensional map view 406 corresponding with the specific geographic locations 206 of the portion of the user profiles 204 and the pet profiles 212 associated with the portion of the user profiles 204. The communication module 118 of the geo-spatial environment 100 may generate the communication associated with at least one user profile (e.g., the user profiles 204 of FIG. 2).

FIG. 2 is an exploded view 250 of the community network module 106 of FIG. 1, according to one embodiment. Particularly, FIG. 2 illustrates the map data 122, a community network 200, a user database 202, user profiles 204, a specific geographic location 206, a map database 208, a pet database 210, and pet profiles 212, according to one embodiment.

The community network 200 may be a network of people, places and/or businesses in the geo-spatial environment 100 associated with the user profiles 204 and the pet profiles 212, each user profile and pet profile 212 having the specific geographic location 206. The user database 202 may contain the user profiles 204 associated with the specific geographic location 206 in the community network 200. The user profiles 204 may capture (e.g., store, record, track, etc.) information of a user (e.g., may include age data, interest data, occupation data, etc.) associated with the users 102 of the specific geographic location 206 in the community network 200. The specific geographic location 206 may refer to a location of the users 102 associated with the user profile in the community network 200.

The map database 208 may contain the map data 122 of any area, region and/or neighborhood of the users 102 associated with the user profiles 204 and pets associated with the pet profiles 212. The pet database 210 may contain the pet profiles 212 associated with the community network 200. The pet profiles 212 may capture information (e.g., may include age data, interest data, etc.) associated with the pets of the specific geographic location 206 in the geo-spatial environment 100.

In the example embodiment illustrated in FIG. 2, the community network module 106 includes the community network 200 containing the user database 202, the map database 208 and the pet database 210 communicating with each other. In addition, the user database which contains the user profiles 204, the specific geographic location 206 communicates with the pet database 210. The pet database 210 contains the pet profiles 212.

The community network 200 of the user profiles 204 may be generated, each user profile associated with the specific geographic location 206. The preseeded pet data may be procured (e.g., from a public source). The groups of user profiles 204 may be automatically generated within the community network 200, each group of user profiles 204 based on the category of the preseeded pet data (e.g., the categories of the preseeded pet data 402 of FIG. 4). The pet profiles 212 may be generated based on the preseeded pet data, each pet profile 212 associated with a user profile.

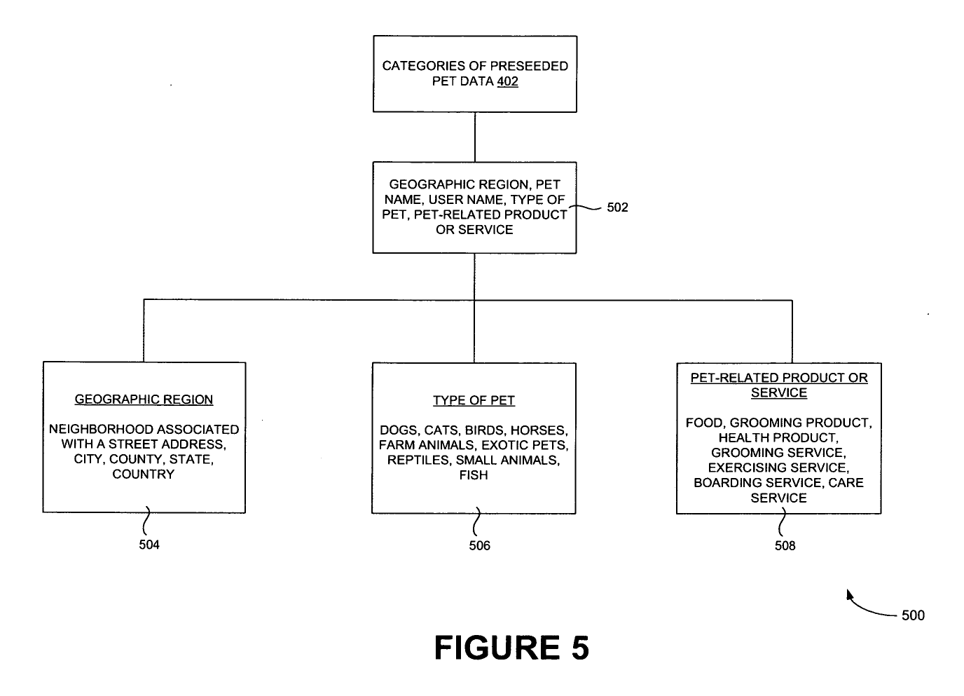

A first geographic region may be determined, and/or a first set of user profiles 204 matching the first geographic region and at least one other category may be identified. The first geographic region may be selected from a group consisting of a neighborhood associated with a street address, a city, a county, a state, and/or a country. The user profiles 204 associated with at least one type of pet (e.g., the type of pet 506 of FIG. 5) may be identified and/or the user profiles 204 associated with at least one of a product and/or a service may be identified. A second geographic region may be determined, a second set of user profiles 204 having the specific geographic location 206 associated with the second geographic region and at least one associated pet profile may be identified, and/or a third geographic region may be determined.

A first instruction set of the geo-spatial environment 100 may enable the community network 200 to include the map database 208 associated with the map data 122, a user database 202 associated with the user profiles 204, each user profile associated with the specific geographic location 206 identifiable in the map data 122, and the pet database 210 associated with the preseeded pet data and the pet profiles 212, each pet profile 212 associated with a user profile. A second instruction set integrated with the first instruction set may generate groups of user profiles 204, each group based on the category of the preseeded pet data (e.g., the categories of the preseeded pet data 402 of FIG. 4).

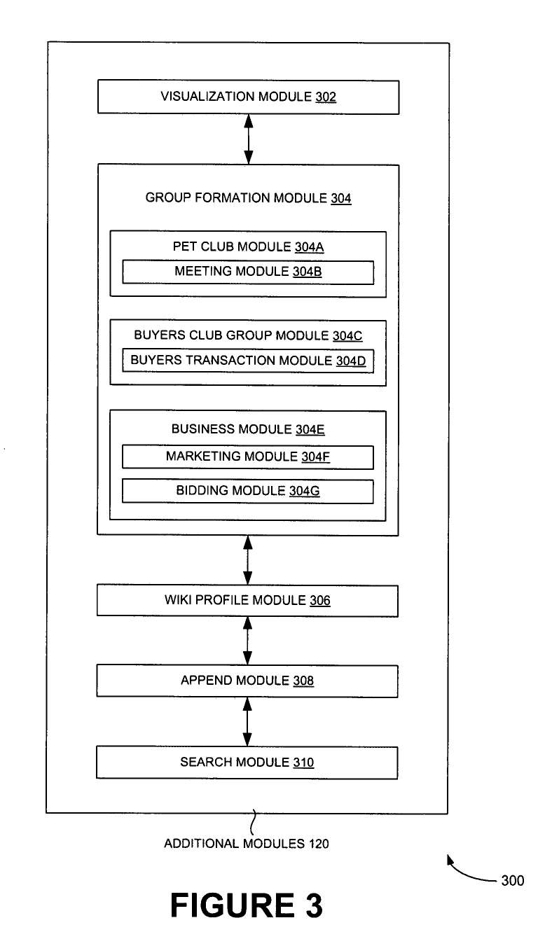

FIG. 3 is an exploded view 300 of the additional modules 120 of FIG. 1, according to one embodiment. Particularly, FIG. 3 illustrates a visualization module 302, a group formation module 304, a pet club module 304A, a meeting module 304B, a buyers club group module 304C, a buyers transaction module 304D, a business module 304E, a marketing module 304F, a bidding module 304G, a wiki profile module 306, an append module 308, and a search module 310, according to one embodiment.

The visualization module 302 may determine a geographic region (e.g., may be selected from a group consisting of a neighborhood associated with street address, city, county, state, and/or country) to select a category of the preseeded pet data (e.g., the categories of the preseeded pet data 402 of FIG. 4) and automatically generate a group of user profiles 204. The group formation module 304 may enable formation of groups based on the user profiles 204 associated with a category (e.g., may include type of pet, and/or pet-related product and/or service) of categories of the preseeded pet data (e.g., the categories of preseeded pet data 402 of FIG. 4). The pet club module 304A may enable formation of a pet club group associated with a type of pet.

The meeting module 304B may schedule meetings associated with the pet club groups and/or generate meeting notifications associated with the meetings in the geo-spatial environment 100. The buyers club group module 304C may enable formation of a buyers club group based on a pet-related product and/or service (e.g., may include food, grooming product, health product, grooming service, exercising service, boarding service, and/or care service) in the geo-spatial environment 100. The buyers transaction module 304D may generate a buyer transaction (e.g., may include a bulk purchase of the pet-related product and/or service) associated with the buyers club group.

The business module 304E may enable formation of a business group based on category of the preseeded pet data (e.g., the categories of the preseeded pet data 402 of FIG. 4) and buyers club groups. The marketing module 304F may generate a consumer communication (e.g., may be selected from a group consisting of marketing brochure, flyer, coupon, and/or frequent shopper offer) via a communication mode (e.g., may include online communication mode and/or physical communication mode) to each user profile 204.

The bidding module 304G may identify the buyers club group and generate a bid transaction (e.g., may be selected from a group consisting of bid transaction to bid up, bid transaction to bid down, bid transaction to place a zero bid, bid transaction to set a reserve price, bid transaction to generate a request for bid, and/or bid transaction to accept a submitted bid) in connection with the product and/or the service. The wiki profile module 306 may generate a wiki profile (e.g., the wiki profiles 408 of FIG. 4) associated with a representation of a user profile (e.g., the representations of user profiles 604 of FIG. 6). The append module 308 may generate content associated with the wiki profiles 408. The search module 310 may generate a search of the user profiles 204 and the pet profiles 212 based on the categories of preseeded pet data 402.

In the example embodiment illustrated in FIG. 3, the additional modules include the visualization module 302, the group formation module 304, the wiki profile module 306, the append module 308, and the search module 310 communicating with each other. In addition, the group formation module 304 includes the pet club module 304A, the meeting module 304B, the buyers club group module 304C, the buyers transaction module 304D, the business module 304E, the marketing module 304F, and the bidding module 304G.

The pet club group communication (e.g., may include invitation, webpage, newsletter, and/or member directory) associated with the pet club group may be generated via the communication mode (e.g., may include online communication mode and/or physical communication mode, etc.) and/or a meeting of the pet club group may be scheduled. The meeting notification may be generated based on the user profiles 204 associated with at least one type of pet (e.g., may be selected from the group consisting of dogs, cats, birds, horses, farm animals, exotic pets, reptiles, small animals, and/or fishes).

The buyers club group may be formed based on the user profiles 204 associated with the product and/or the service (e.g., may be selected from a group consisting of food, grooming product, health product, grooming service, exercising service, boarding service, and/or care service). A transaction may be generated based on the product and/or the service, A request for bids may be generated and/or the buyers club group associated with the third geographic region may be identified. The bid transaction associated with the product and/or the service sought by the buyers club group may also be generated and submitted.

The zero bid associated with the product and/or the service may be placed and/or the reserve price associated with the product and/or the service may be determined (e.g., the price associated with the product and/or the service may be bid up and/or down). For example, based on a submitted bid being accepted, an online order may be generated for the product and/or the service and/or an online payment transaction associated with the online order may be generated.

The visualization module 302 of the geo-spatial environment 100 may determine a geographic region, to select at least one other category of the preseeded pet data (e.g., the categories of preseeded pet data 402 of FIG. 4), and to automatically generate, in the display view 404, a group of user profiles 204. Each specific geographic location 206 of each user profile (e.g., the user profiles 204 of FIG. 2) may be associated with the geographic region and the other category of the preseeded pet data 402 associated with each user profile 204. The group formation module 304 of the geo-spatial environment 100 may enable formation of a group based on user profiles 204 associated with the category of preseeded pet data 402 (e.g., may include type of pet, product and/or service, etc).

The pet club module 304A of the geo-spatial environment 100 may enable formation of the pet club group associated with at least one type of pet. The meeting module 304B of the geo-spatial environment 100 may schedule meetings associated with the pet club group and to generate meeting notifications associated with the meetings. The buyers club group module 304C of the geo-spatial environment 100 may enable formation of a buyers club group based on the product and/or service. The buyers transaction module 304D of the geo-spatial environment 100 may generate a business transaction (e.g., a bulk purchase transaction of the product and/or the service) associated with the buyers group.

In addition, the bulk purchase transaction may include an online purchase transaction. The business module 304E of the geo-spatial environment 100 may enable formation of a business group based on the category of the preseeded pet data (e.g., the categories of preseeded pet data 402 of FIG. 4) and at least one buyers club group. The marketing module 304F of the geo-spatial environment 100 may generate a consumer communication (e.g., may be selected from a group consisting of marketing brochure, flyer, coupon, and/or frequent shopper offer, etc.) via a communication mode (e.g., may include online communication mode and/or physical communication mode, etc.) to each user profile in a group of user profiles 204.

The bidding module 304G of the geo-spatial environment 100 may identify a buyers club group and to generate a bid transaction (e.g., may be selected from a group consisting of bid transaction to bid up, bid transaction to bid down, bid transaction to place a zero bid, bid transaction to set a reserve price, bid transaction to generate a request for bid, and/or a bid transaction to accept a submitted bid, etc.) associated with the product and/or service. The product and/or the service may be selected from a group consisting of a food, a grooming product, a health product, a grooming service, an exercising service, a boarding service, and/or a care service, etc.

The wiki profile module 306 of the geo-spatial environment 100 may generate a wiki profile (e.g., the wiki profiles 408 of FIG. 4) associated with at least one representation of a user profile (e.g., the representations of user profiles 604 of FIG. 6). The append module 308 of the geo-spatial environment 100 may generate, with the wiki profile 408, content associated with the wiki profile 408. The search module 310 may generate a search associated with the user profiles 204 and the pet profiles 212 based on the category of the preseeded pet data (e.g., the categories of preseeded pet data 402 of FIG. 4).

FIG. 4 is a block diagram 400 illustrating generation of pet profiles 212 associated with user profiles, according to one embodiment. Particularly, FIG. 4 illustrates the display module 116, the user database 202, the user profiles 204, the first user profile 204A, other user profiles 204B, the map database 208, the pet database 210, the pet profiles 212, the first pet profile 212A, the visualization module 302, the pet club module 304A, the meeting module 304B, the buyers club group module 304C, the buyers transaction module 304D, the business module 304E, the marketing module 304F, the bidding module 304G, the wiki profile module 306, the append module 308, the search module 310, a categories of preseeded pet data 402, a display view 404, a three-dimensional map view 406, wiki profiles 408, and a content 410, according to one embodiment.

The categories of preseeded pet data 402 may categorize the preseeded pet data associated with the user profile (e.g., the user profiles 204 of FIG. 2) based on a geographic region, a pet name, a user name, a type of pet, and/or a pet-related product and/or service. The display view 404 may display in the three-dimensional map view 406 the content 410 associated with the wiki profiles 408. The three-dimensional map view 406 may enable the users (e.g., the users 102 of FIG. 1) to view neighbors' profiles in the geo-spatial environment 100. The content 410 may provide information of the user (e.g., the users 102 of FIG. 1) associated with the wiki profile 408 in the geo-spatial environment 100.

In the example embodiment illustrated in FIG. 4, the display view 404 includes the three-dimensional map view 406 and the first pet profile 212A. The pet profiles 212 of the pet database 210 associated with the user profiles 204 of the user database 202 may be generated within the community network 200 based on the categories of preseeded pet data 402. The display view 404 displays the wiki profiles 408 and the content 410 associated with the users 102 and the pets. The users 102 of the geo-spatial environment 100 may visualize marketing brochure, flyer, frequent shopper offer, meeting notices, invitations, etc. associated with the pet club groups in the display view 404.

The display view 404 may be generated to include the three-dimensional map view 406 embodied by the community network 200, a first group of user profiles 204, each user profile represented at a location in the three-dimensional map view 406 corresponding to the specific geographic location 206 with which each user profile is associated. The pet profiles 212 associated with the first set of user profiles 204 may be identified. The first set of user profiles 204 and the pet profiles 212 associated with the first set of user profiles 204 may be generated automatically in the display view 404.

The formation of a pet club group may be enabled based on the user profiles 204 associated with the type of pet. The online order for a bulk quantity of the product and/or the service may be generated. The online payment transaction associated with the online order may be generated. The consumer communication may be generated via a communication mode to each user (e.g., the users 102 of FIG. 1) in the second set of user profiles 204. The type of pet and the product and/or the service may be selected. The consumer communication may be generated via the communication mode to each user 102 in the second set of user profiles 204 associated with the type of pet and/or the product and/or the service.

The consumer communication may be selected from a group consisting of a marketing brochure, a flyer, a coupon, and/or a frequent shopper offer. The communication mode may be selected from a group consisting of an online communication mode and/or a physical communication mode. The wiki profiles 408 associated with specific geographic locations (e.g., the specific geographic location 206 of FIG. 2) may be generated simultaneously in the three-dimensional map view 406. The content 410 associated with the wiki profiles 408 may be generated.

The geo-spatial environment 100 may include a third instruction set integrated with the first instruction and the second instruction set to display the three-dimensional map view 406, embodied by the community network 200, to include representations of a first group of the user profiles 204 and the pet profiles 212 associated with the first group, each representation of a user profile (e.g., the representations of user profiles 604 of FIG. 6) of the first group may be displayed at a location in the three-dimensional map view 406 corresponding to the specific geographic location 206 associated with the user profile.

FIG. 5 is a classification view of the categories of preseeded pet data 402 of FIG. 4, according to one embodiment. Particularly, FIG. 5 illustrates a field 502, a geographic region 504, a type of pet 506, and a pet-related product or service 508, according to one embodiment. The field 502 may display pet name, user name, type of pet, pet related product and/or service associated with the geographic region 504. The geographic region 504 may be a location and/or a region of a neighborhood associated with a street address, a city, a county, a state, and/or a country. The type of pet 506 may be selected from a group consisting of dog, cats, birds, horses, farm animals, exotic pets, reptiles, small animals, fish, etc. The pet-related product and service 508 may be selected from a group consisting of a food, a grooming product, a health product, a grooming service, an exercising service, a boarding service, and/or a care service.

In the example embodiment illustrated in FIG. 5, the users (e.g., the users 102 of FIG. 1) may form the pet club groups based on the categories of preseeded pet data 402 that includes the geographic region 504, the type of pet 506 and the pet-related product and service 508. The user 102 may select the type of pet and/or the type of product and/or service.

FIG. 6 is a user interface view 600 of searching for a pet profile based on the search query, according to one embodiment. Particularly, FIG. 6 illustrates the three-dimensional map view 406, the wiki profile 408, the content 410, a profile menu option 602, representations of user profiles 604, a search by geographic region option 606, and a search by type of pet option 608, according to one embodiment.

The profile menu option 602 may enable the users 102 to search for the user profiles 204 and/or the pet profiles 212 based on the categories of preseeded pet data 402 (e.g., may include geo-graphic region, pet name, user name, type of pet, and/or pet related product and/or service). The representations of user profiles 604 may display the profiles associated with the users 102 on the three-dimensional map view 406 in which the specific geographic location 206 of each user profile (e.g., the user profiles 204 of FIG. 2) corresponds with a location in the three-dimensional map view 406. The search by geographic region option 606 may enable the users 102 to search the user profiles 204 and/or the pet profiles 212 based on the geographic region (e.g., by entering street address, radius, city, state, country, etc.). The search by type of pet option 608 may enable the users 102 to search for any type of pets (e.g., may include dogs, cats, birds, horses, farm animals, exotic pets, etc.) in the geo-spatial environment 100.

In the example embodiment illustrated in FIG. 6, the user interface view 600 may enable the users 102 to search for the user profiles 204 and/or the pet profiles 212 through the search by geographic region option 606. The profile menu option 602 may enable the users 102 to search for any kind of pet, list types of pets, list pet-related product or service, view pet club groups, buyers club groups and/or business groups through the search by type of pet option 608.

The three-dimensional map view 406 may enable the users to view their wiki profiles 408 and the content 410 associated with the profiles. For example, the user interface view 600 may enable users to view the dog of the week (e.g., Sparky) and cat of the week (e.g., Wink) and/or adopt the pets. The user (e.g., the users 102 of FIG. 1) may also view April as the horse of the month and view health tips to keep their own horses in top shape.

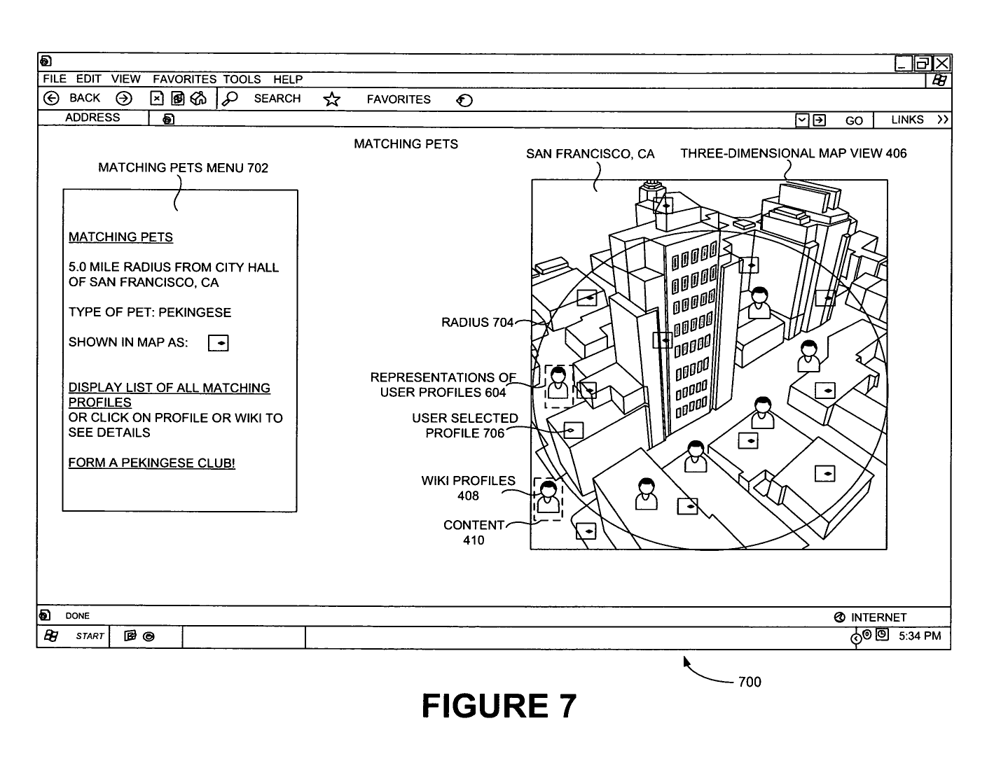

FIG. 7 is a user interface view 700 of searching for matching pets based on a threshold radius in a geographic location, according to one embodiment. Particularly, FIG. 7 illustrates the three-dimensional map view 406, the wiki profiles 408, the content 410, the representations of user profiles 604, a matching pets menu option 702, a radius 704, and a user selected profile 706, according to one embodiment.

The matching pets menu option 702 may enable the users 102 to search for the matching pets based on the type of pet, breed and/or location of the pets. The radius field 704 may enable the users 102 to select the matching pets located within a threshold radius away from the address of the user. The user selected profile 706 may be the profile displayed in the three-dimensional map view 406 which is selected by the users 102 based on the search criteria.

In the example embodiment illustrated in FIG. 7, the user interface view 700 may enable the users 102 to select the matching pets from the matching pets menu option 702 based on the radius (e.g., 5 miles), location (e.g., City hall of San Francisco, Calif.) and/or the type of pet (e.g., Pekingese). The user interface view 700 may enable the users 102 to view list of all matching profiles by using a display list of all matching profiles link of the matching pets menu option 702. In addition, the users 102 may also click on profile or wiki to see details. The user interface view 700 may enable the users 102 to form a club (e.g., a Pekingese club) by using the form a Pekingese club link of the matching pets menu option 702.

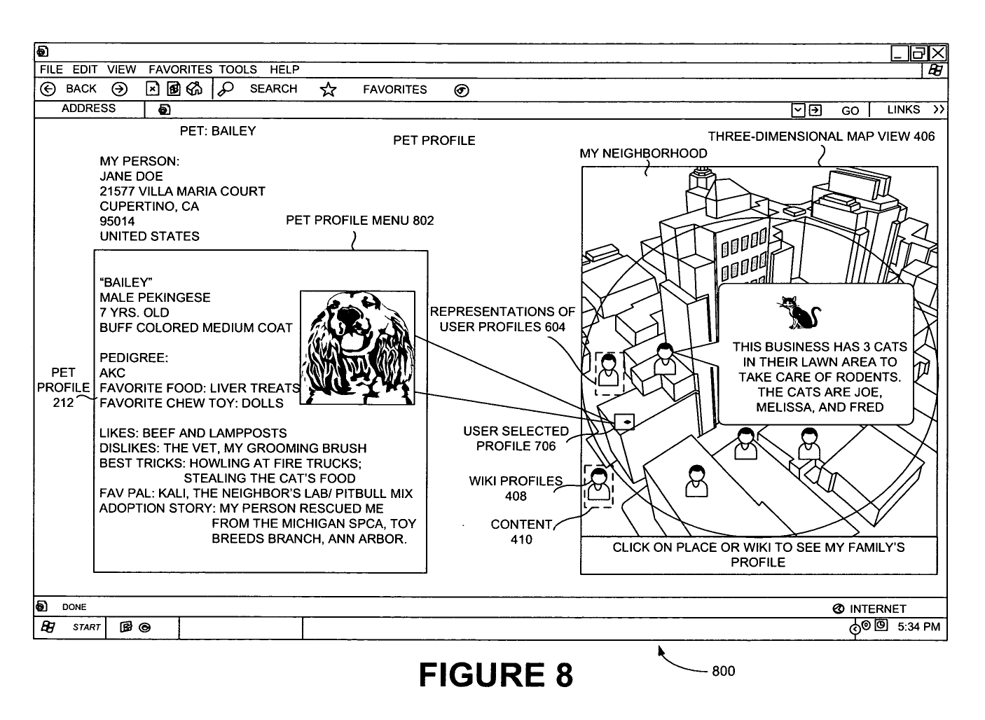

FIG. 8 is a user interface view 800 displaying information of the pet profiles 212 of FIG. 2, according to one embodiment. Particularly, FIG. 8 illustrates the pet profile 212, the three-dimensional map view 406, the wiki profiles 408, the content 410, the representations of user profiles 604, the user selected profile 706, and a pet profile menu option 802, according to one embodiment. The pet profile menu option 802 may enable the users 102 to view the profiles of the pet (e.g., the pet profiles 212 of FIG. 2) in the geo-spatial environment 100.

In the example embodiment illustrated in FIG. 8, the user interface view 800 may enable the users 102 to view the pet profiles 212 (e.g., “Bailey”, male Pekingese, 7 years old, buff colored medium coat). The user interface view 800 may also enable the users 102 to view the pets Favorite Food (e.g., Liver Treats), Favorite Chew Toy (e.g., Dolls), Likes (e.g., Beef and Lampposts), Dislikes (e.g., The Vet, My Grooming Brush), Best Tricks (e.g., howling at fire trucks, stealing the cat's food), favorite pal (e.g., Kali, the neighbor's Lab/Pitbull Mix) and Adoption story (e.g., My person rescued me from the Michigan SPCA, Toy breeds branch, Ann Arbor) through the pet profile menu option 802. In addition, the users 102 may also click on place or wiki to see their profile.

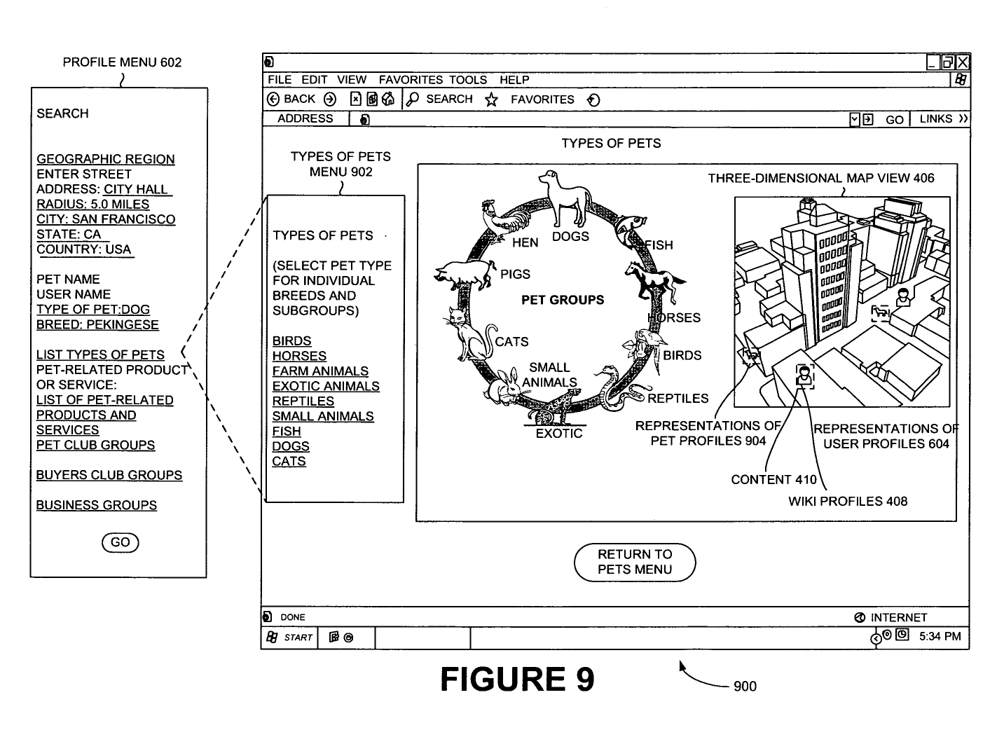

FIG. 9 is a user interface view 900 displaying the types of pets represented in the three-dimensional map view 406, according to one embodiment. Particularly, FIG. 9 illustrates the three-dimensional map view 406, the wiki profiles 408, the content 410, the profile menu option 602, the representations of user profiles 604, a types of pets menu option 902, and representations of pet profiles 904, according to one embodiment.

The types of pets menu option 902 may enable the users 102 to select any kind of pet from individual breeds and subgroups. The representations of pet profiles 904 may display profiles associated with the pet on the three-dimensional map view 406 in the geo-spatial environment 100.

In the example embodiment illustrated in FIG. 9, the user interface view 900 may enable the users 102 to search (e.g., based on the geographic region) and select types of pets (e.g., birds, horses, farm animals, exotic animals, reptiles, small animals, fish, dogs, and/or cats) for individuals and/or subgroups, through the types of pets menu option 902. The user interface view 900 may enable the users 102 to view the representations of pet profiles 904 and/or the wiki profiles 408 on the three-dimensional map view 406.

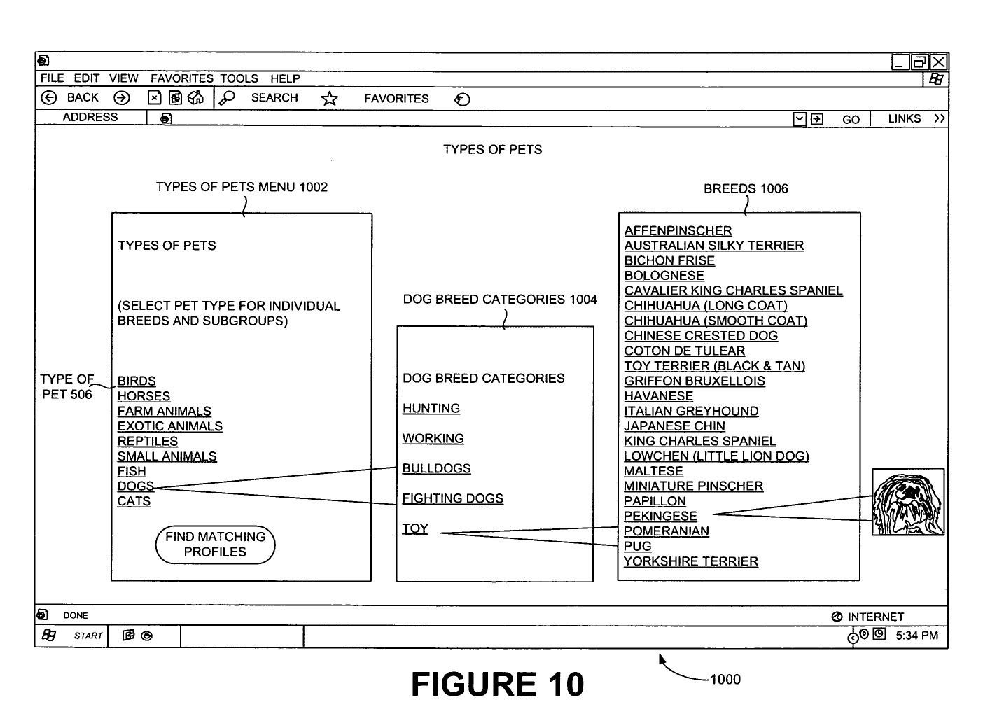

FIG. 10 is a user interface view 1000 displaying a list of types of pets, according to one embodiment. Particularly, FIG. 10 illustrates the type of pet 506, types of pets menu option 1002, a dog breed categories 1004, and breeds 1006, according to one embodiment.

The types of pets menu option 1002 may enable the users 102 to select any kind of pets depending on the individual breeds and subgroups. The dog breed categories option 1004 may enable the users 102 to view the breeds of dogs, that are grouped into different categories depending on the size, and how the breeds are used (e.g., hunting, working, bulldogs, fighting dogs, and/or toy.). The breeds 1006 may enable the users 102 to view and select different types of breeds from the toy group of the dog breed categories 1004.

In the example embodiment illustrated in FIG. 10, the user interface view 1000 may enable the users 102 to select from various types of pets (e.g., the birds, the horses, the farm animals, the dogs, etc.), through the types of pets menu option 1002. In addition, the users 102 may also select individual breeds (e.g., dog) depending on the pet type grouped into different categories (e.g., hunting, working, bulldogs, fighting dogs and/or toy, etc.). The user interface view 1000 may enable the users to select various subgroups (e.g., the toy group) from the dog breed categories option 1004 which contains a list of the smallest dog breeds (e.g., Affenpinscher, Australian silky terrier, Bichon Frise, Papillion, and/or Pekingese, etc.).

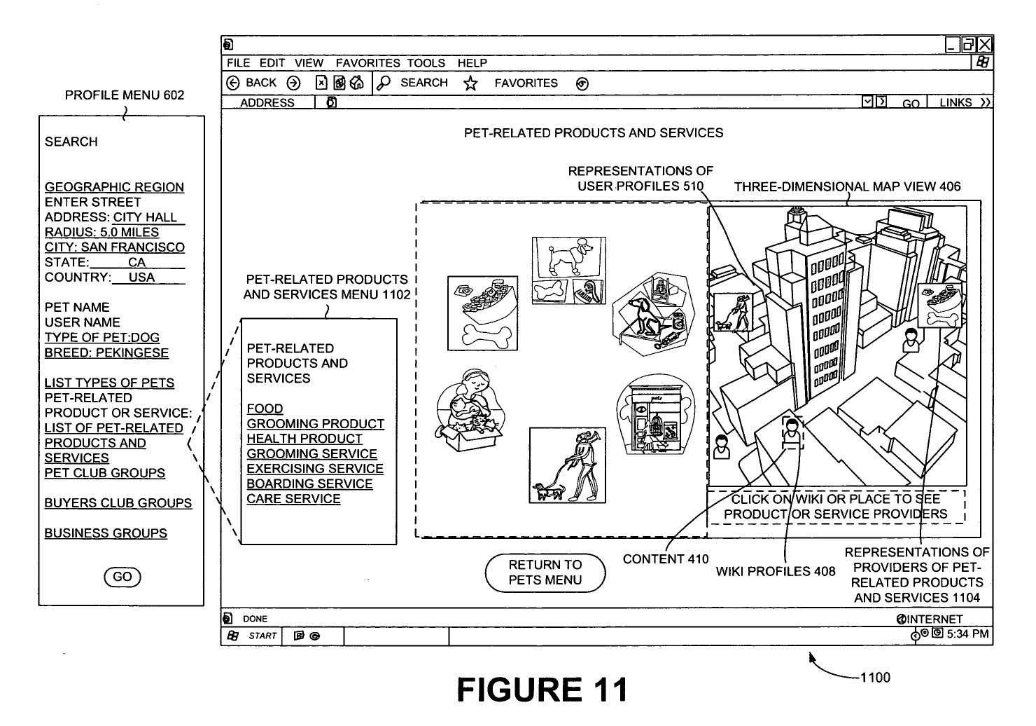

FIG. 11 is a user interface view 1100 displaying pet-related product and services, according to one embodiment. Particularly, FIG. 11 illustrates the three-dimensional map view 406, the wiki profiles 408, the profile menu option 602, the representations of user profiles 604, a pet-related products and services menu option 1102, and representations of providers of pet-related products and services 1104, according to one embodiment.

The pet-related products and services menu option 1102 may enable the users 102 to view and select the pet related products and services (e.g., food, grooming product, health product, grooming service, exercising service, boarding service, and/or care service, etc.) for purchase. The representations of providers of pet-related products and services 1104 may display providers associated with the pet-related products and services that are available to the users 102 in the three-dimensional map view 406.

In the example embodiment illustrated in FIG. 11, the user interface view 1100 may enable the users 102 to search and select various pet-related products and services (e.g., food, grooming product, health product, grooming service, exercising service, boarding service, care service, etc.). In addition, the user interface view 1100 may enable the users 102 to view the providers associated with the pet-related products and services by clicking on the click on wiki or place to see product and service providers link of the three-dimensional map view 406.

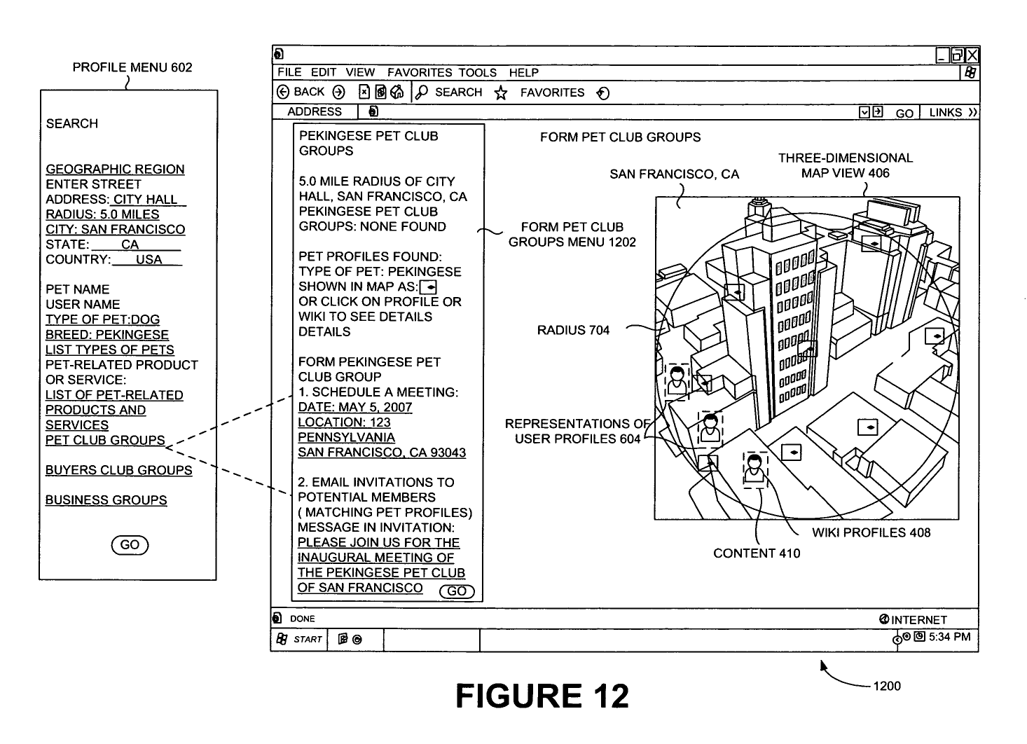

FIG. 12 is a user interface view 1200 of forming pet club groups, according to one embodiment. Particularly, FIG. 12 illustrates the three-dimensional map view 406, the wiki profiles 408, the content 410, the profile menu option 602, the representations of user profiles 604, the radius 704, and a form pet club groups menu option 1202, according to one embodiment. The form pet club groups menu option 1202 may enable the users 102 to form pet club groups in the geo-spatial environment 100.

In the example embodiment illustrated in FIG. 12, the user interface view 1200 may enable the users 102 to form the pet club groups (e.g., form Pekingese pet club groups) through the form pet club groups menu option 1202. In addition, the user interface view 1200 may enable the users 102 to find the pet profiles 212 within a threshold radius (e.g., 5 mile radius of City Hall, San Francisco, Calif.) and/or click on profiles or wiki to see details. The users 102 may also schedule meetings (e.g., date: May 5, 2007, Location: 123 Pennsylvania, San Francisco, Calif. 93043) and/or email invitations to potential members (e.g., users 102 with matching pet profiles).

The geo-spatial environment 100 may include a fourth instruction set to display, in the three-dimensional map view 406, a representation of a pet club group of user profiles 204 based on the type of pet.

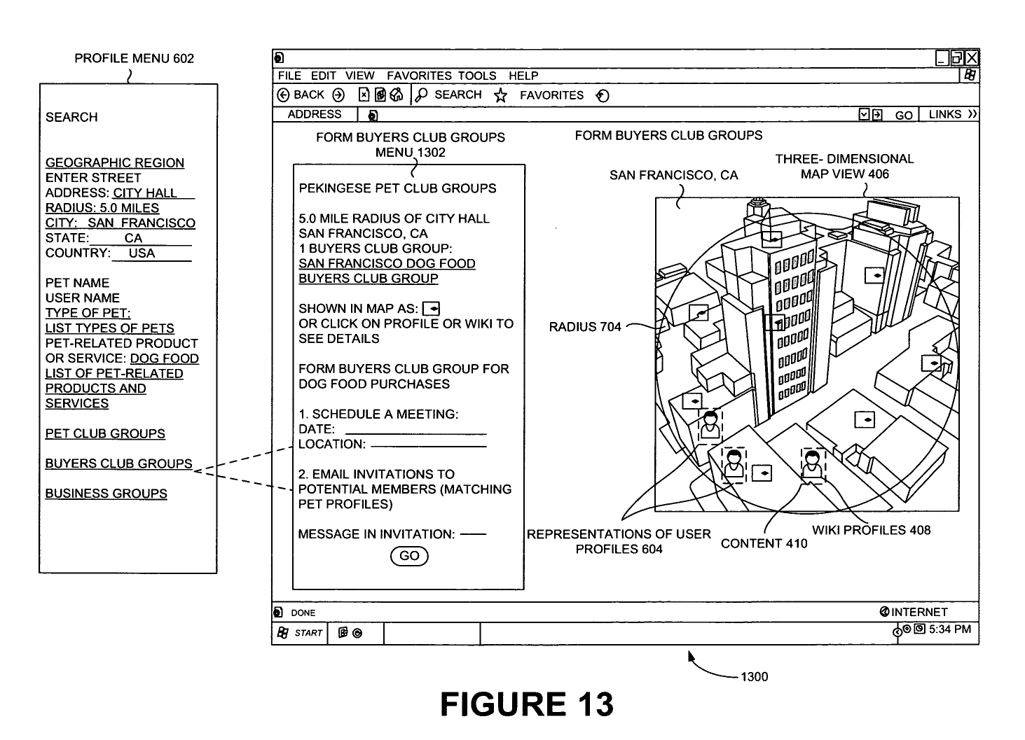

FIG. 13 is a user interface view 1300 of the buyers club group module 304C of FIG. 3, according to one embodiment. Particularly, FIG. 13 illustrates the three-dimensional map view 406, the wiki profiles 408, the content 410, the profile menu option 602, the representations of user profiles 604, the radius 704, and a form buyers club groups menu option 1302, according to one embodiment. The form buyers club groups menu option 1302 may enable the users 102 to form buyers club group (e.g., using the buyers club group module 304C of FIG. 3) based on the user profiles 204 associated with at least one of a pet related product and/or a service (e.g., food, grooming product, health product, grooming service, exercising service, boarding service, and/or care service.).

In the example embodiment illustrated in FIG. 13, the user interface view 1300 may enable the users 102 to form buyer club groups within a threshold radius (e.g., within 5 miles), using the form buyers club groups menu option 1302. The users 102 may also click on profiles or wiki to see details and/or form buyer club groups (e.g., groups for dog purchases). In addition, the user interface view 1300 may enable the users 102 to schedule meeting and/or email invitation (e.g., message) to the potential members (e.g., users 102 with matching pet profiles).

The geo-spatial environment 100 may include a fifth instruction set to display, in the three-dimensional map view 406, a representation of a buyers club group of user profiles 204 associated with the product and/or the service.

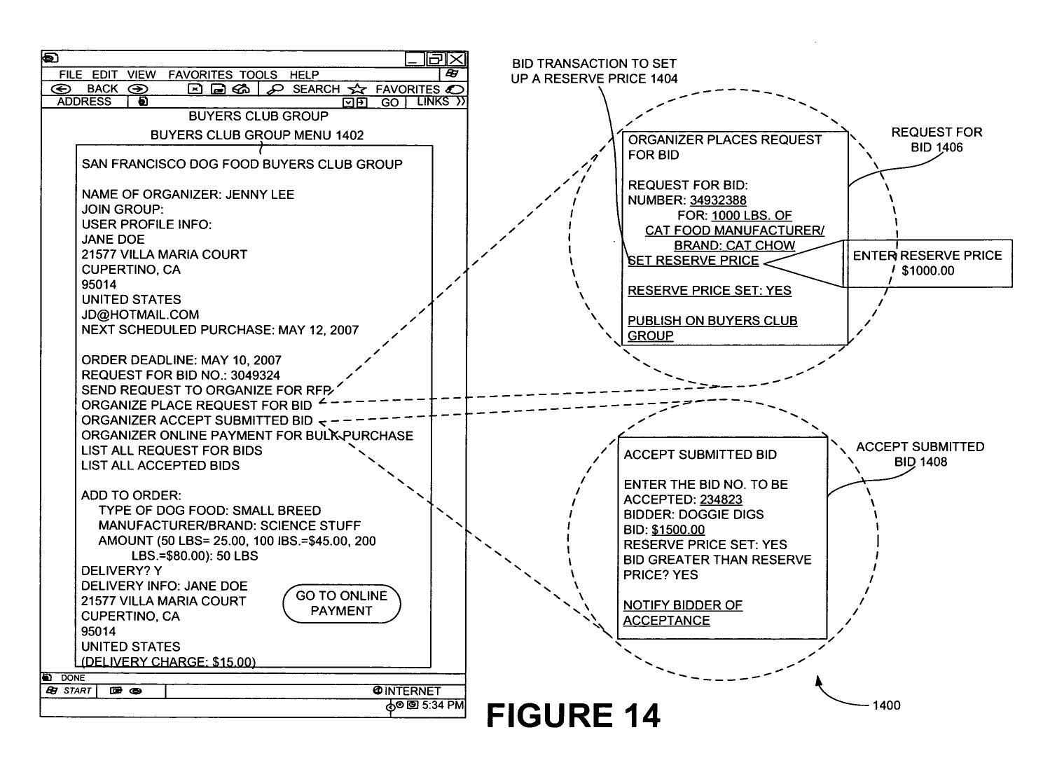

FIG. 14 is a user interface view 1400 of buyers club displaying bid transactions associated with a pet-related product and a service, according to one embodiment. Particularly, FIG. 14 illustrates a buyers club group menu option 1402, a bid transaction to set up a reserve price option 1404, a request for bid option 1406, and an accept submitted bid option 1408, according to one embodiment.

The buyers club group menu option 1402 may provide information to the members of the buyers club about a status of a submitted bid. The bid transaction to set up a reserve price option 1404 may enable an organizer to set a reserve price for the bid submitted by the members (e.g., the users 102 of FIG. 1). The request for bid option 1406 may enable the organizer (e.g., the users 102 of FIG. 1) to place a request for bid. The accept submitted bid option 1408 may enable the users 102 to accept the submitted bid by entering a bid number.

In the example embodiment illustrated in FIG. 14, the user interface view 1400 may enable the users 102 to view the profile information of an organizer (e.g., Jenny Lee) through the buyers club group menu option 1402. The users 102 may also view a next scheduled purchase related to a pet product and/or service the organizer wants to purchase. In addition, the user interface view 1400 may enable the users 102 to view order deadlines, bids placed and/or submitted by the organizer, list all requests for bids through the list all requests for bids link, and/or list all accepted bids through the list all accepted bids link. The users 102 may also set a reserve price (e.g., $1000.00 for 1000 lbs of cat food) for bids and/or notify the bidder of acceptance through the notify bidder of acceptance link.

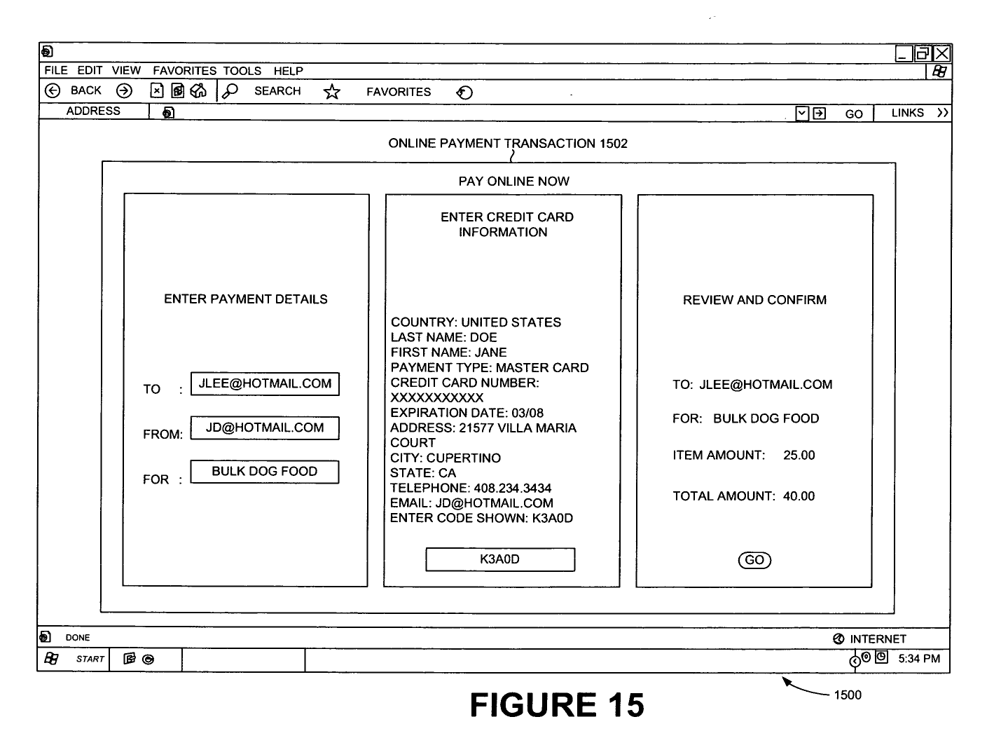

FIG. 15 is a user interface view 1500 of making online payments related to pet products and/or services, according to one embodiment. Particularly, FIG. 15 illustrates an online payment transaction option 1502, according to one embodiment. The online payment transaction option 1502 may enable the users 102 to make online payments related to pet products and/or services.

In the example embodiment illustrated in FIG. 15, the user interface view 1500 may enable the users 102 to enter the payment details for the transaction to be made by a user (e.g., jd@hotmail.com) to another user (e.g., jlee@hotmail.com) for an item (e.g., bulk dog food). The user interface view 1500 may enable the users 102 to enter credit card information (e.g., First Name, Last Name, Payment Type, Credit Card Number, Expiration date, address, City, State, Telephone, email, etc.) related to the payment of pet-related products and/or services and confirm the details entered by entering a code shown (e.g., k3a0d). In addition, the user interface view 1500 may provide a “GO” link that enables the users 102 to preview and confirm the payments made associated with the pet-related products and/or services.

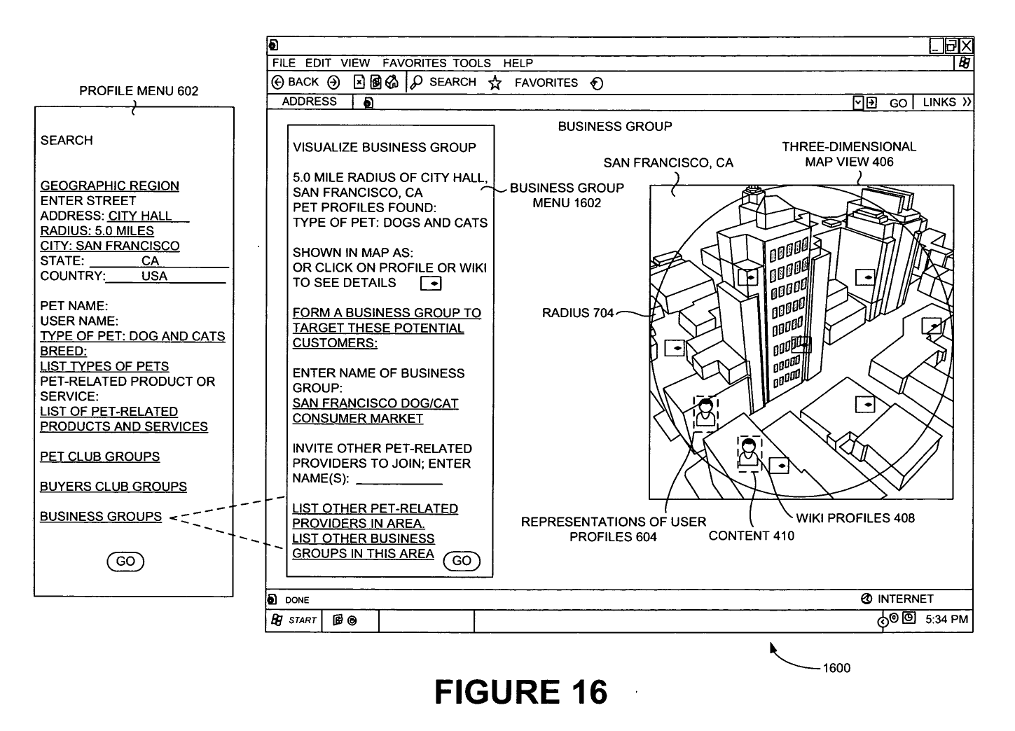

FIG. 16 is a user interface view 1600 of business module 304E of FIG. 3, according to one embodiment. Particularly, FIG. 16 illustrates the three-dimensional map view 406, the wiki profiles 408, the content 410, representations of user profiles 604, the radius 704, the profile menu option 602, a business group menu option 1602, according to one embodiment. The business group menu option 1602 may enable the users 102 to visualize business group(s) and/or form business group(s).

In the example embodiment illustrated in FIG. 16, the user interface view 1600 may enable the user (e.g., the users 102 of FIG. 1) to view a business group (e.g., 5 miles radius of City Hall, San Francisco, Calif.). The users 102 may also view the pet profiles 212 and type of pet (e.g., dogs and cats). The user interface view 1600 may enable the users 102 to view profiles or wikis by clicking on the click on profile or wiki to see details link. In addition, the user interface view 1600 may enable the users 102 to form a business group (e.g., San Francisco Dog/Cat Consumer market) and invite other pet-related providers to join by entering their name(s). A list other pet-related providers in area link and a list other business groups in this area link in the business group menu option 1602 may enable users 102 to find other pet-related providers and/or other business groups in that area.

The geo-spatial environment 100 may include a sixth instruction set to display in the three-dimensional map view 406, a representation of a business group associated with the product and/or the service.

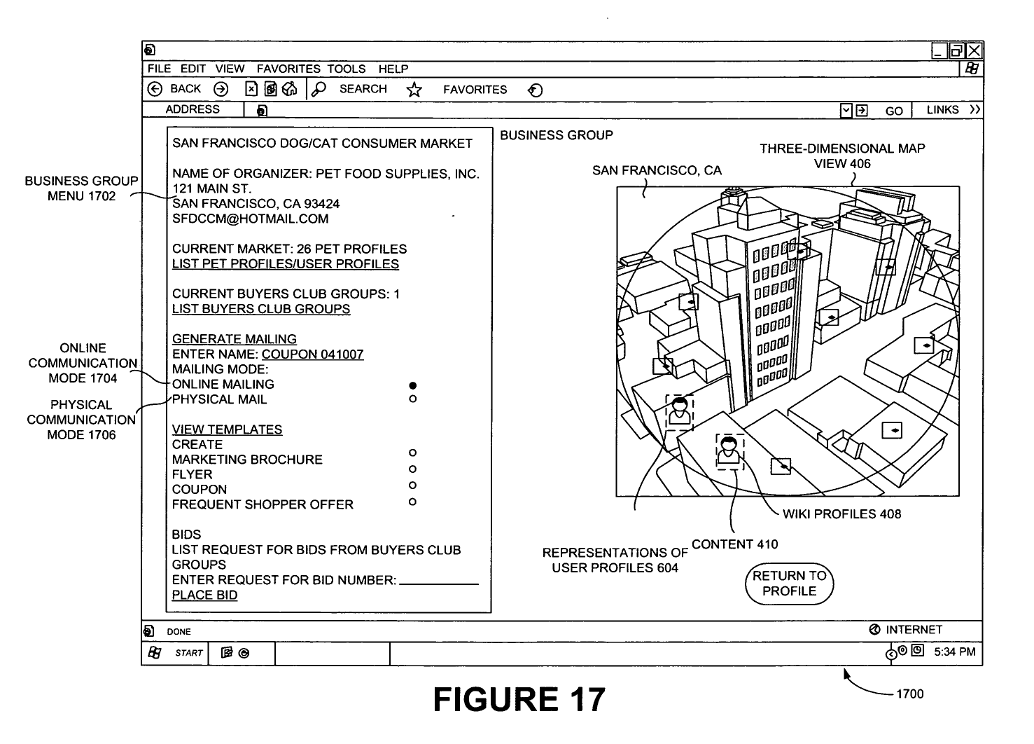

FIG. 17 is a user interface view 1700 of business module 304E of FIG. 3 illustrating various communication modes, according to one embodiment. Particularly, FIG. 17 illustrates a business group menu option 1702, an online communication mode 1704, and a physical communication mode 1706, according to one embodiment. The business group menu option 1702 may display information (e.g., list of user profiles 204 and/or pet profiles 212) and provide different communication modes to the user (e.g., San Francisco Dog/Cat consumer market). The online communication mode 1704 may enable the users 102 to communicate online for buying and/or selling pet-related products and/or services. The physical communication mode 1706 may enable the users 102 to physical communicate for buying and/or selling pet-related products and/or services.

In the example embodiment illustrated in FIG. 17, the user interface view 1700 may display to the users 102, list of pet profiles 212 (e.g., 26 pet profiles) and/or user profiles 204 and/or current buyers club groups (e.g., 1) for current marketing. The user interface view 1700 may enable the users 102 to generate mailing through different mailing modes (e.g., online mailing, physical mail) by entering identification name (e.g., coupon 041007). In addition, the user interface view 1700 may enable the users 102 to view templates, create marketing brochure, flyer coupon, and/or frequent shopper offer. The user interface view 1700 may also enable the users 102 to list request for bids from buyers club groups, enter request for bid number and/or place bid.

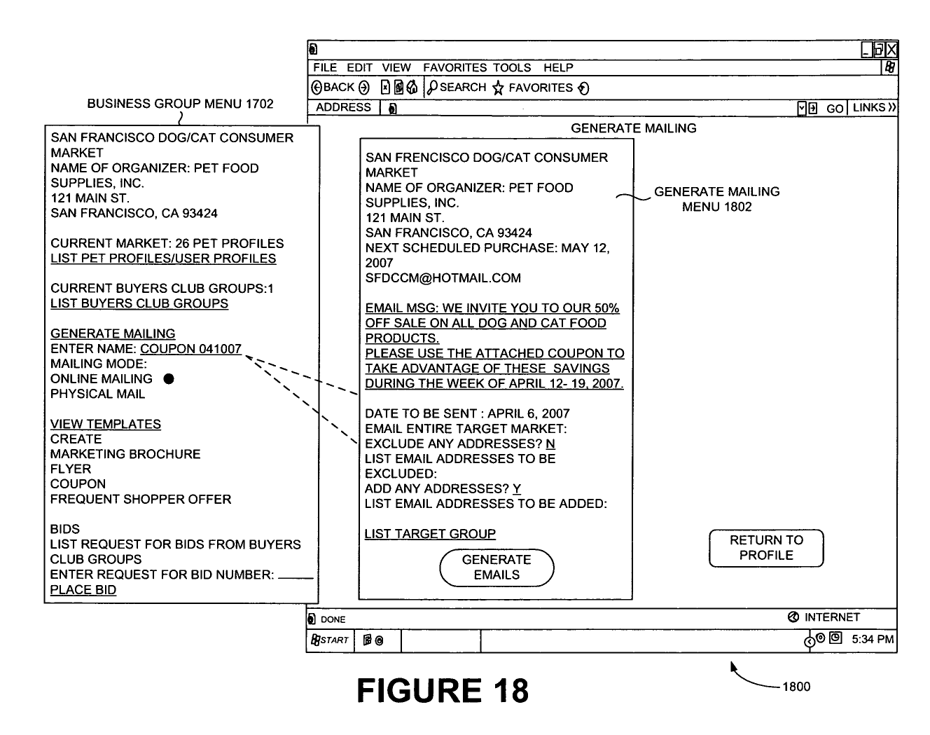

FIG. 18 is a user interface view 1800 of generating mailing(s), according to one embodiment. Particularly, FIG. 18 illustrates the business group menu option 1702 and a generate mailing menu option 1802, according to one embodiment. The generate mailing menu option 1802 may enable the members (e.g., the users 102 of FIG. 1) of the business group to generate mail(s) and send to the list of target group(s).

In the example embodiment illustrated in FIG. 18, the user interface view 1800 may enable the users 102 to generate mailings through the generate mailing menu option 1802. In addition, the user interface view 1800 may enable the users 102 to schedule the mailings to an organizer (e.g., Pet Food Supplies, Inc, 121 Main St, San Francisco, Calif. 93424), and/or view list of target group, list of email addresses to be excluded and/or view list of email addresses to be added through the links.

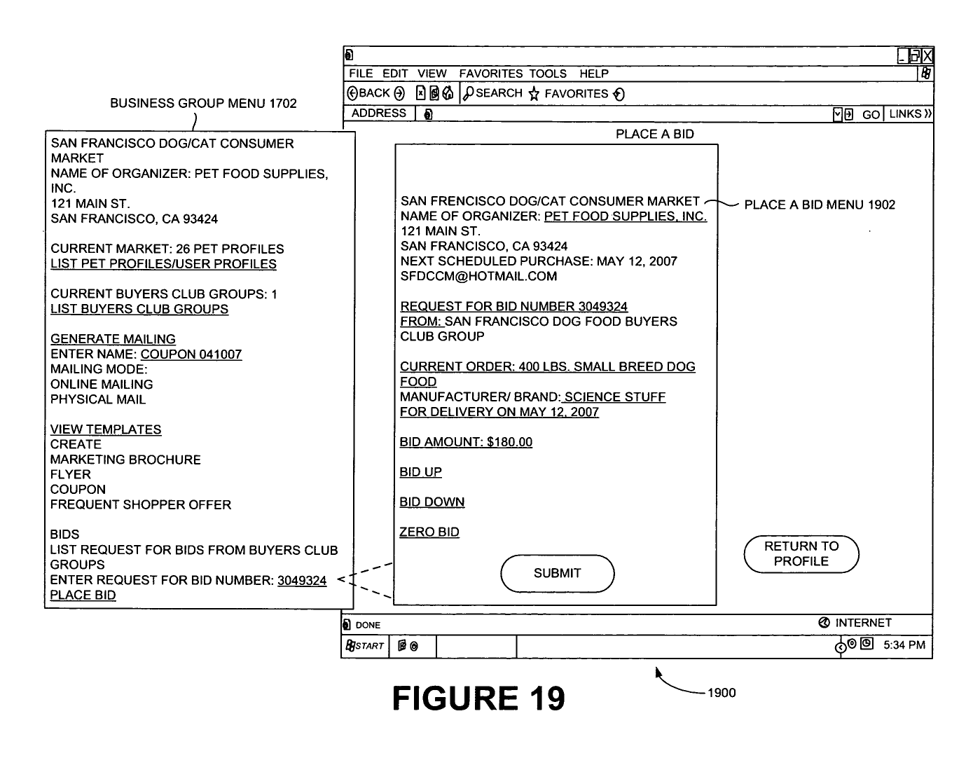

FIG. 19 is a user interface view 1900 of placing a bid, according to one embodiment. Particularly, FIG. 19 illustrates the business group menu option 1702, and a place a bid menu option 1902, according to one embodiment. The place a bid menu option 1902 may enable the members (e.g., the users 102 of FIG. 1) of the business group to place a bid through the place a bid menu option 1902.

In the example embodiment illustrated in FIG. 19, the user interface view 1900 may enable the organizers to place a bid (e.g., bid up a price, bid down a price, zero bid, etc.) associated with the pet-related product and/or service.

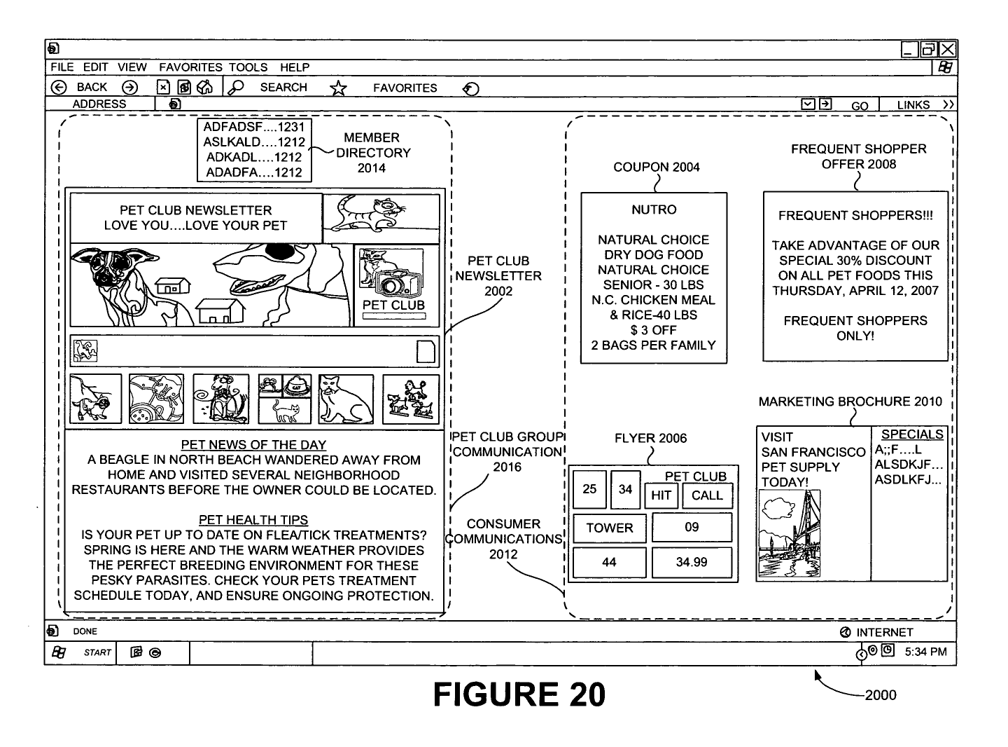

FIG. 20 is a user interface view 2000 of communication associated with the pet club groups and consumers, according to one embodiment. Particularly, FIG. 20 illustrates a pet club newsletter 2002, a coupon 2004, a flyer 2006, a frequent shopper offer 2008, a marketing brochure 2010, consumer communications 2012, a member directory 2014, and a pet club group communication 2016, according to one embodiment.

The pet club newsletter 2002 may be distributed publications of news and/or upcoming events of the pets published by the pet clubs. The coupon 2004 may be a voucher that provides a discount for purchasing a pet-related product and/or service. The flyer 2006 may be a printed advertisement (e.g., a single page leaflet) of pets events, pets services and/or other activities related to pets. The frequent shopper offer 2008 may provide frequent shoppers cards to avail discounts for the members to buy any pet-related products and/or services in the pet club groups. The marketing brochure 2010 may be a leaflet/ a booklet advertising a pet event, a pet product and/or a service.

The consumer communications 2012 may generate communications via the communication mode (e.g., an online communication and/or a physical communication mode) to each user (e.g., the users 102 of FIG. 1) associated with one of the types of pet and/or pet-related product and/or service selected from a group consisting of the marketing brochure, the flyer, the coupon, the frequent shopper offer etc. The member directory 2014 may contain information of the members (e.g., the users 102 of FIG. 1) and/or their pets associated with pet club groups. The pet club group communication 2016 may enable the communication of the pet club group members (e.g., the users 102 of FIG. 1) associated with the pets.

In the example embodiment illustrated in FIG. 20, the user interface view 2000 may enable the members of the pet club groups to buy any pet-related products and/or services through the pet club newsletter 2002, the coupon 2004, the flyer 2006, the frequent shopper offer 2008, and/or the marketing brochure 2010. The members of the pet club may communicate with other members of the pet club groups through the consumer communications 2012, the member directory 2014 and/or the pet club group communication 2016.

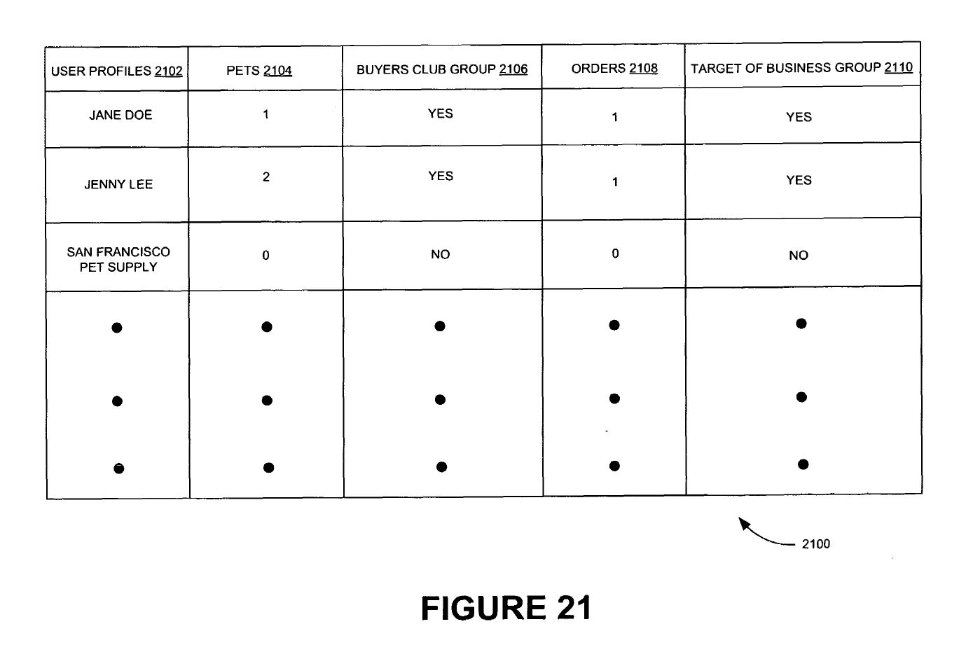

FIG. 21 is a table view 2100 of information associated with pet-related products and/or services, according to one embodiment. Particularly, FIG. 21 illustrates a user profiles field 2102, a pets field 2104, a buyers club group field 2106, an orders field 2108, and a target of business group field 2110, according to one embodiment. The user profiles field 2102 may display the profiles of the user (e.g., the users 102 of FIG. 1) associated with pets they own. The pets field 2104 may display a number of pets owned by the user 102. The buyers club group field 2106 may display the groups joined by the users 102 to buy/sell pet-related products and/or services. The orders field 2108 may display number of orders placed by the users 102 related to pet products and/or services. The target of business group field 2110 may display a status of the target in the business of the business group reached.

In the example embodiment illustrated in FIG. 21, the user profiles field 2102 displays “Jane Doe” in the first row, “Jenny Lee” in the second row and “San Francisco Pet Supply” in the third row of the user profiles field 2102 column. The pets field 2104 displays “1” pet for Jane Doe in the first row, “2” pets for Jenny Lee in the second row and “0” pets for San Francisco Pet Supply in the third row of the pets field 2104 column. The buyers club group field 2106 displays “Yes” in the first row, “Yes” in the second row and “No” in the third row of the buyers club group field 2106 column (e.g., Jane Doe and Jenny Lee are the members for buyers club group and San Francisco Pet Supply not a member for buyers club group). The orders field 2108 displays “1” for Jane Doe in the first row, “1” for Jenny Lee in the second row and “0” for San Francisco Pet Supply in the third row of the orders field 2108 column. The target of business group field 2110 displays “Yes” in the first row, “Yes” in the second row and “No” in the third row of the target of business group field 2110 column (e.g., Jane Doe and Jenny Lee are the target members for business group and San Francisco is not a target member for business group).

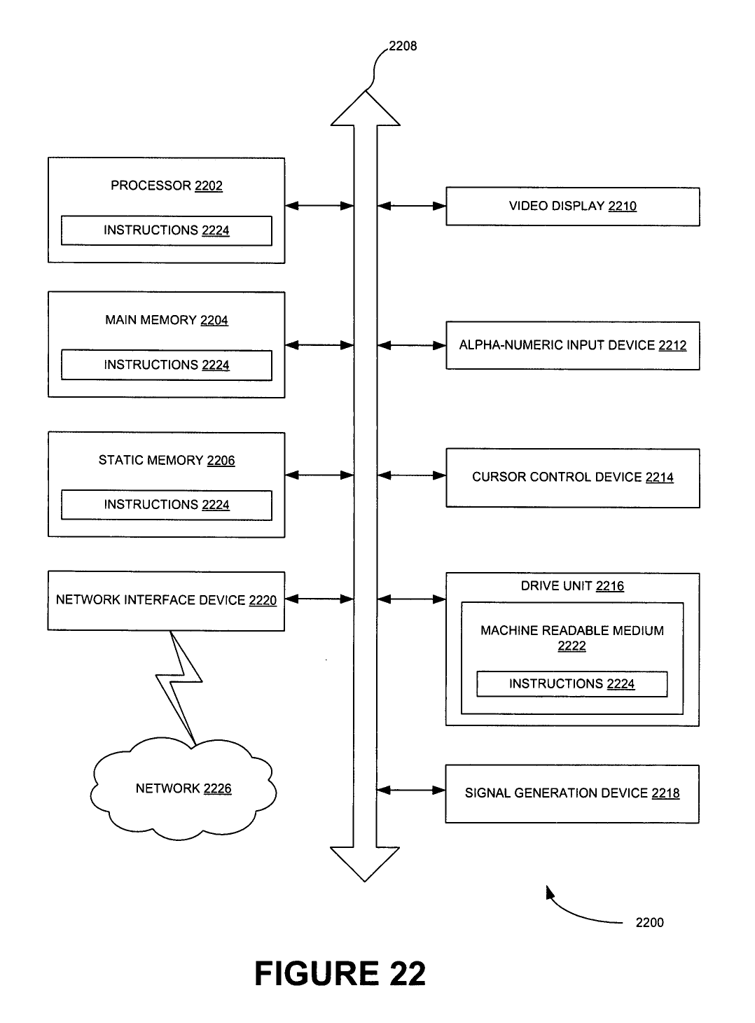

FIG. 22 is a diagrammatic system view 2200 of a data processing system in which any of the embodiments disclosed herein may be performed, according to one embodiment. Particularly, the system view 2200 of FIG. 22 illustrates a processor 2202, a main memory 2204, a static memory 2206, a bus 2208, a video display 2210, an alpha-numeric input device 2212, a cursor control device 2214, a drive unit 2216, a signal generation device 2218, a network interface device 2220, a machine readable medium 2222, instructions 2224, and a network 2226, according to one embodiment.

The diagrammatic system view 2200 may indicate a personal computer and/or a data processing system in which one or more operations disclosed herein may be performed. The processor 2202 may be a microprocessor, a state machine, an application-specific integrated circuit, a field programmable gate array, etc. (e.g., Intel® Pentium® processor). The main memory 2204 may be a dynamic random access memory and/or a primary memory of a computer system. The static memory 2206 may be a hard drive, a flash drive, and/or other memory information associated with the data processing system.

The bus 2208 may be an interconnection between various circuits and/or structures of the data processing system. The video display 2210 may provide graphical representation of information on the data processing system. The alpha-numeric input device 2212 may be a keypad, a keyboard and/or any other input device of text (e.g., a special device to aid the physically challenged). The cursor control device 2214 may be a pointing device such as a mouse.

The drive unit 2216 may be the hard drive, a storage system, and/or other longer term storage subsystem. The signal generation device 2218 may be a bios and/or a functional operating system of the data processing system. The network interface device 2220 may be a device that performs interface functions such as code conversion, protocol conversion and/or buffering required for communication to and from the network 2226. The machine readable medium 2222 may provide instructions on which any of the methods disclosed herein may be performed. The instructions 2224 may provide source code and/or data code to the processor 2202 to enable any one or more operations disclosed herein.

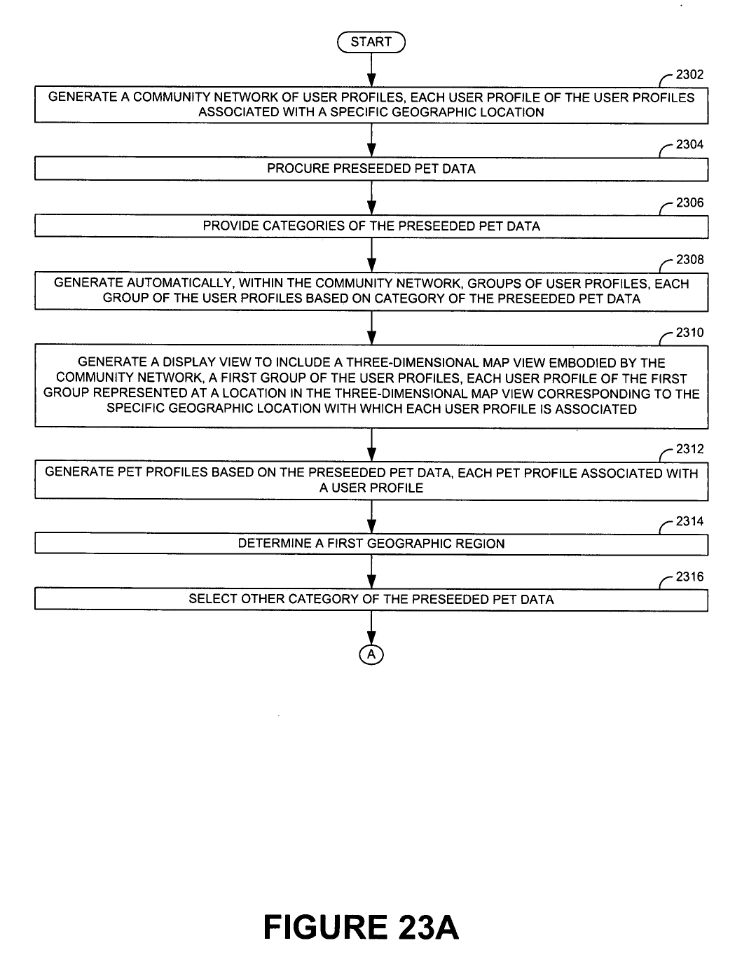

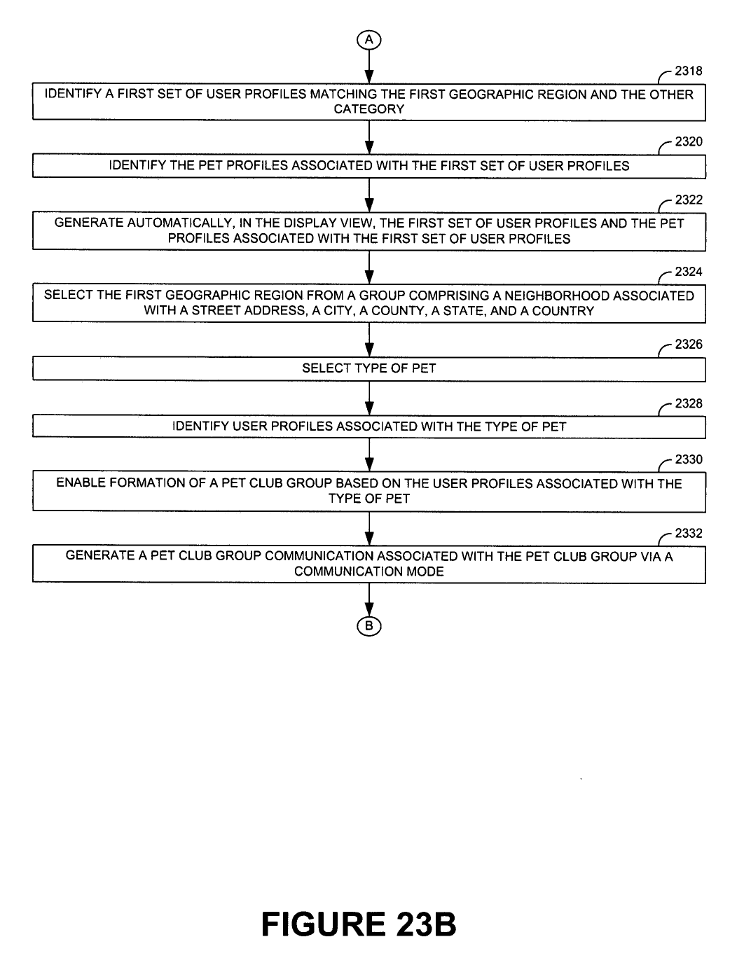

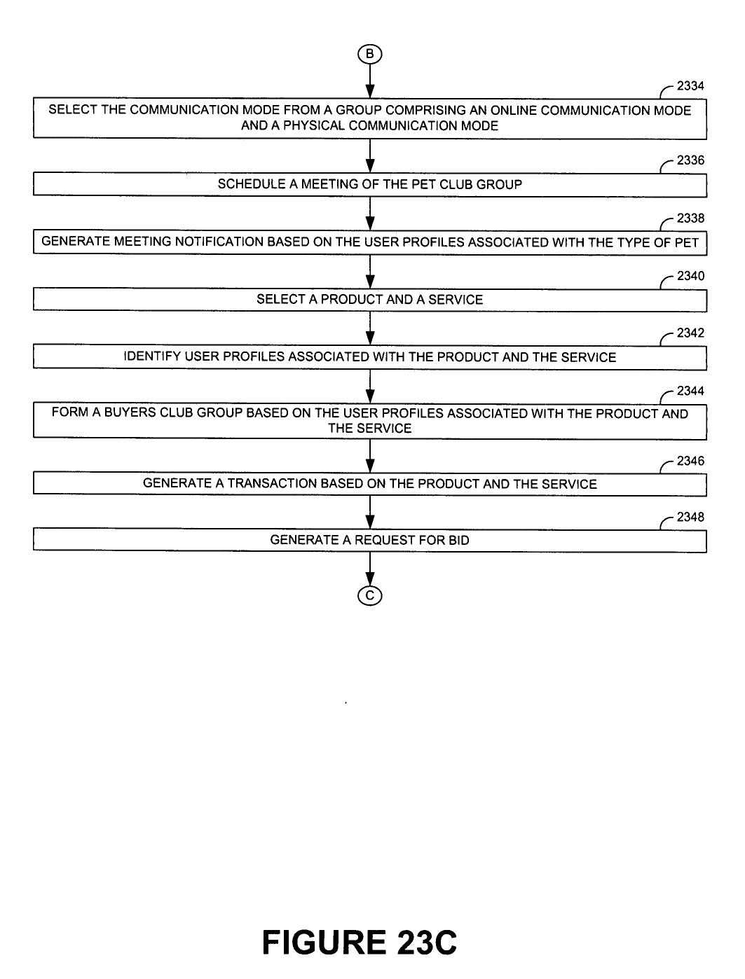

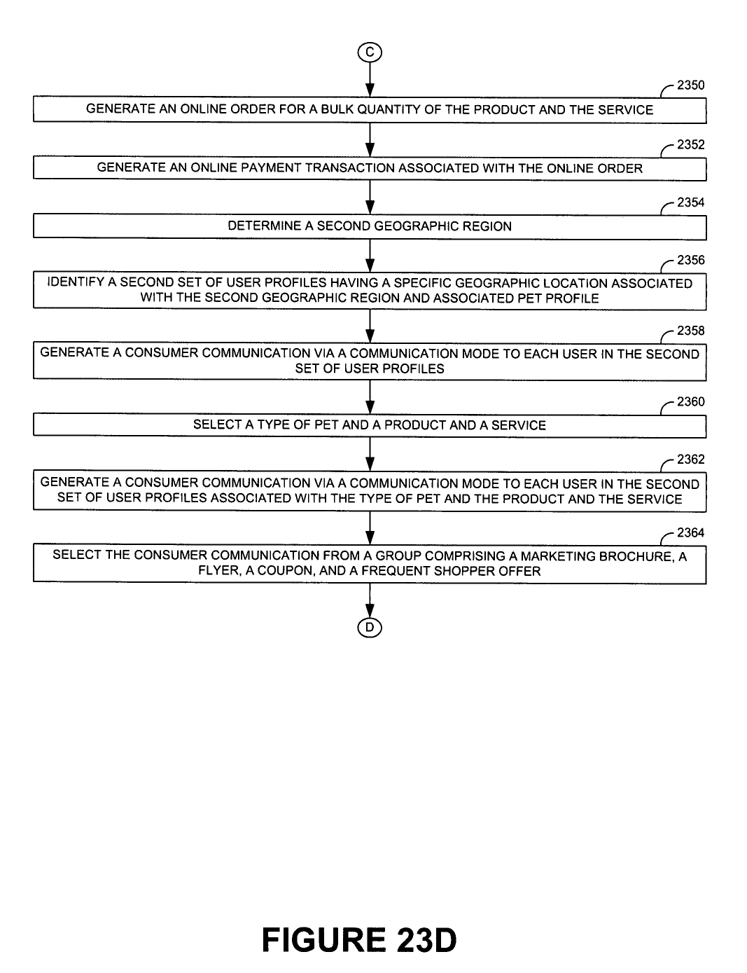

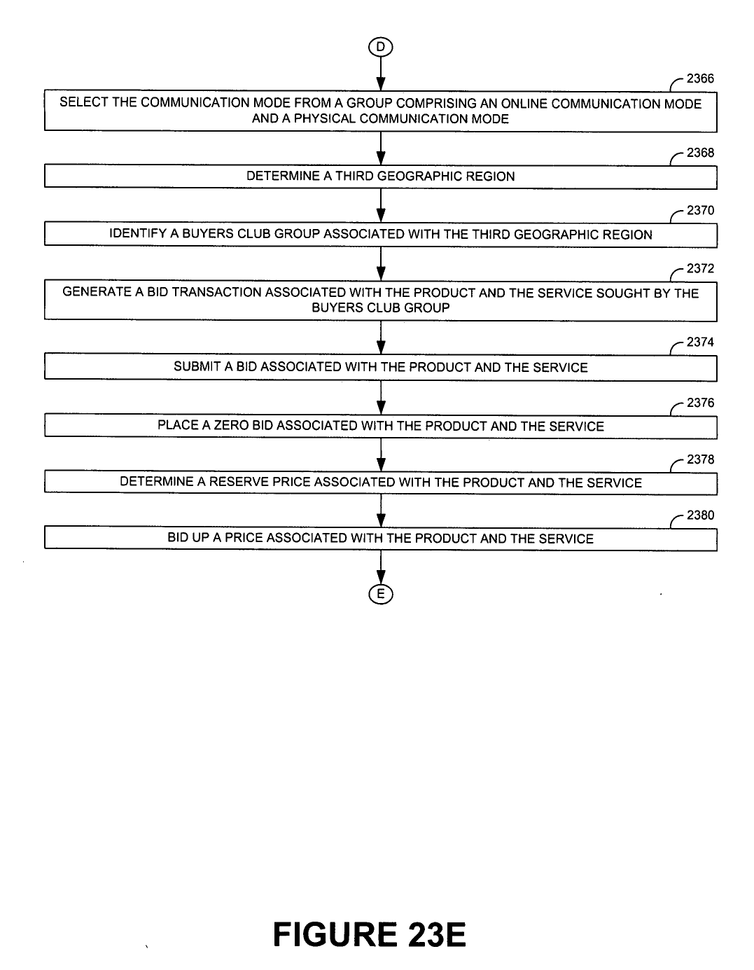

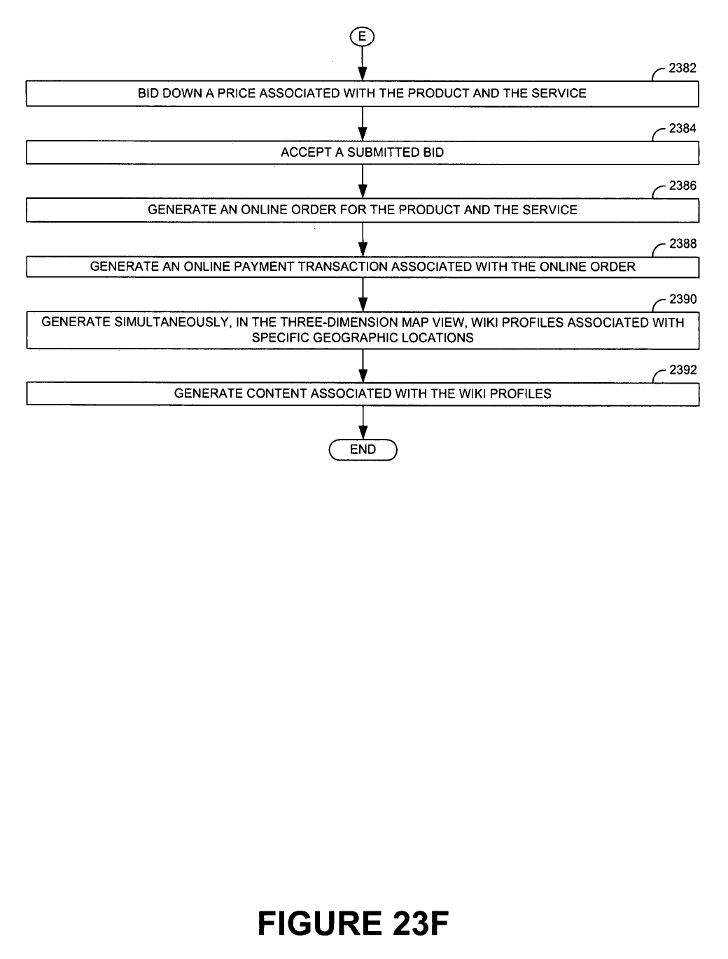

FIG. 23A is a process flow of forming a community network based on preseeded pet data, according to one embodiment. In operation 2302, a community network (e.g., the community network 200 of FIG. 2) of user profiles (e.g., the user profiles 204 of FIG. 2) may be generated, each user profile associated with a specific geographic location (e.g., the specific geographic location 206 of FIG. 2). In operation 2304, preseeded pet data may be procured. In operation 2306, categories of the preseeded pet data (e.g., the categories of preseeded pet data 402 of FIG. 4) may be provided. In operation 2308, groups of user profiles 204 may be generated automatically within the community network 200, each group based on a category of the preseeded pet data 402.

In operation 2310, a display view (e.g., the display view 404 of FIG. 4) may be generated to include a three-dimensional map view (e.g., the three-dimensional map view 406 of FIG. 4) embodied by the community network 200, a first group, each user profile 204 of the first group represented at a location in the three-dimensional map view 406 corresponding to the specific geographic location 206 with which each user profile 204 is associated. In operation 2312, pet profiles (e.g., the pet profiles 212 of FIG. 2) may be generated based on the preseeded pet data, each pet profile 212 associated with a user profile (e.g., the user profiles 204 of FIG. 2). In operation 2314, a first geographic region may be determined. In operation 2316, one other category of the preseeded pet data 402 may be selected.

FIG. 23B is a continuation of the process flow of FIG. 23A illustrating additional processes, according to one embodiment. In operation 2318, a first set of user profiles 204 matching the first geographic region and the other category may be identified. In operation 2320, the pet profiles 212 associated with the first set of user profiles 204 may be identified. In operation 2322, the first set of user profiles 204 and the pet profiles 212 associated with the first set of user profiles 204 may be generated automatically, in the display view 404.

In operation 2324, the first geographic region may be selected from a group comprising a neighborhood associated with a street address, a city, a county, a state, and a country. In operation 2326, a type of pet may be selected. In operation 2328, user profiles 204 associated with the type of pet may be identified. In operation 2330, formation of a pet club group may be enabled based on the user profiles 204 associated with the type of pet. In operation 2332, a pet club group communication associated with the pet club group may be generated via a communication mode.

FIG. 23C is a continuation of the process flow of FIG. 23B illustrating additional processes, according to one embodiment. In operation 2334, the communication mode may be selected from a group comprising an online communication mode and/or a physical communication mode (e.g., using the communication module 118 of FIG. 1). In operation 2336, a meeting of the pet club group may be scheduled. In operation 2338, meeting notification may be generated based on the user profiles 204 associated with the type of pet. In operation 2340, a product and/or a service may be selected. In operation 2342, user profiles 204 associated with the product and/or the service may be identified. In operation 2344, a buyers club group may be formed based on the user profiles 204 associated with the product and/or the service (e.g., using the buyers club group module 304C of FIG. 3). In operation 2346, a transaction may be generated based on the product and/or the service. In operation 2348, a request for bids may be generated (e.g., through the bidding module 304G of FIG. 3).

FIG. 23D is a continuation of the process flow of FIG. 23C illustrating additional processes, according to one embodiment. In operation 2350, an online order for a bulk quantity of the product and/or the service may be generated. In operation 2352, an online payment transaction associated with the online order may be generated (e.g., using the business module 304E of FIG. 3). In operation 2354, a second geographic region may be determined. In operation 2356, a second set of user profiles 204 having a specific geographic location (e.g., the specific geographic location 206 of FIG. 2) associated with the second geographic region and associated pet profile 212 may be identified.

In operation 2358, a consumer communication may be generated via the communication mode to each user in the second set of user profiles 204. In operation 2360, the type of pet and the product and/or the service may be selected. In operation 2362, a consumer communication may be generated via the communication mode to each user in the second set of user profiles 204 associated with the type of pet and the product and/or the service. In operation 2364, the consumer communication may be selected from a group comprising a marketing brochure, a flyer, a coupon, and/or a frequent shopper offer.

FIG. 23E is a continuation of the process flow of FIG. 23D illustrating additional processes, according to one embodiment. In operation 2366, the communication mode may be selected from a group comprising the online communication mode and/or the physical communication mode (e.g., using the communication module 118 of FIG. 1). In operation 2368, a third geographic region may be determined. In operation 2370, a buyers club group associated with the third geographic region may be identified. In operation 2372, a bid transaction associated with the product and/or the service sought by the buyers club group may be generated. In operation 2374, a bid associated with the product and the service may be submitted (e.g., through the bidding module 304G of FIG. 3). In operation 2376, a zero bid associated with the product and the service may be placed. In operation 2378, a reserve price associated with the product and the service may be determined. In operation 2380, a price associated with the product and the service may be bid up.

FIG. 23F is a continuation of the process flow of FIG. 23E illustrating additional processes, according to one embodiment. In operation 2382, the price associated with the product and/or the service may be bid down. In operation 2384, the submitted bid may be accepted. In operation 2386, the online order may be generated for the product and the service. In operation 2388, an online payment transaction associated with the online order may be generated (e.g., using the business module 304E of FIG. 3). In operation 2390, wiki profiles (e.g., the wiki profiles 408 of FIG. 4) associated with the specific geographic locations 206 may be generated simultaneously in the three-dimensional map view 406. In operation 2392, content associated with the wiki profiles 408 may be generated.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or Digital Signal Processor (DSP) circuitry). For example, the community network module 106, the map module 108, the data procurement module 110, the category module 112, the group module 114, the display module 116, the communication module 118, the additional modules 120, the visualization module 302, the group formation module 304, the pet club module 304A, the meeting module 304B, the buyers club group module 304C, the buyers transaction module 304D, the business module 304E, the marketing module 304F, the bidding module 304G, the wiki profile module 306, the append module 308, and the search module 310 of FIGS. 1-20 may be enabled using a community network circuit, a map circuit, a data procurement circuit, a category circuit, a group circuit, a display circuit, a communication circuit, additional circuits, a visualization circuit, a group formation circuit, a pet club circuit, a meeting circuit, a buyers club group circuit, a buyers transaction circuit, a business circuit, c marketing circuit, a bidding circuit, a wiki profile circuit, a append circuit, a search circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrated rather than a restrictive sense.

What is claimed is:

1. A method, comprising:
generating a community network of user profiles, each user profile of the user profiles associated with a specific geographic location;
procuring preseeded pet data;
providing categories of the preseeded pet data;
automatically generating, within the community network, groups of user profiles, each group of the groups of user profiles based on at least one category of the preseeded pet data; and
generating a display view to include a three-dimensional map view embodied by the community network, a first group of the groups of user profiles, each user profile of the first group represented at a location in the three-dimensional map view corresponding to the specific geographic location with which each user profile is associated.

2. The method of claim 1, further comprising:
generating pet profiles based on the preseeded pet data, each pet profile of the pet profiles associated with a user profile of the user profiles.

3. The method of claim 1, wherein the categories of the preseeded pet data comprise:
a user name, a geographic region, a pet name, a type of pet, at least one of a product and a service.

4. The method of claim 3, further comprising:
determining a first geographic region;
selecting at least one other category of the categories of the preseeded pet data;
identifying a first set of user profiles matching the first geographic region and the at least one other category;
identifying the pet profiles associated with the first set of user profiles; and
automatically generating, in the display view, the first set of user profiles and the pet profiles associated with the first set of user profiles.

5. The method of claim 4, further comprising:
selecting the first geographic region from a group comprising a neighborhood associated with a street address, a city, a county, a state, and a country.

6. The method of claim 3, further comprising:
selecting at least one type of pet;
identifying user profiles associated with the at least one type of pet; and
enabling formation of a pet club group based on the user profiles associated with the at least one type of pet.

7. The method of claim 6, further comprising:
generating a pet club group communication associated with the pet club group via a communication mode, wherein the pet club group communication includes an invitation, a webpage, a newsletter, and a member directory.

8. The method of claim 7, further comprising:
selecting the communication mode from a group comprising an online communication mode and a physical communication mode.

9. The method of claim 6, further comprising:
scheduling a meeting of the pet club group.

10. The method of claim 9, further comprising:
generating meeting notification based on the user profiles associated with the at least one type of pet.

11. The method of claim 3, comprising:
selecting at least one of a product and a service;
identifying user profiles associated with the at least one of a product and a service; and
forming a buyers club group based on the user profiles associated with the at least one of a product and a service.

12. The method of claim 11, further comprising:
generating a transaction based on the at least one of a product and a service.

13. The method of claim 12, further comprising:
generating a request for bid.

14. The method of claim 13, further comprising:
generating an online order for a bulk quantity of the at least one of a product and a service.

15. The method of claim 14, further comprising:
generating an online payment transaction associated with the online order.

16. The method of claim 3, further comprising:
determining a second geographic region;
identifying a second set of user profiles having a specific geographic location associated with the second geographic region and at least one associated pet profile; and
generating a consumer communication via a communication mode to each user in the second set of user profiles.

17. The method of claim 16, further comprising:
selecting at least one of a type of pet and at least one of a product and a service; and
generating a consumer communication via a communication mode to each user in the second set of user profiles associated with the at least one of the type of pet and the at least one of a product and a service.

18. The method of claim 17, further comprising:
selecting the consumer communication from a group comprising a marketing brochure, a flyer, a coupon, and a frequent shopper offer.

19. The method of claim 17, further comprising:
selecting the communication mode from a group comprising an online communication mode and a physical communication mode.

20. The method of claim 3, further comprising:
determining a third geographic region;
identifying a buyers club group associated with the third geographic region; and
generating a bid transaction associated with the at least one of a product and a service sought by the buyers club group.

21. The method of claim 20, further comprising:
submitting a bid associated with the at least one of a product and a service.

22. The method of claim 20, further comprising:
placing a zero bid associated with the at least one of a product and a service.

23. The method of claim 20, further comprising:
determining a reserve price associated with the at least one of a product and a service.

24. The method of claim 20, further comprising:
bidding up a price associated with the at least one of a product and a service.

25. The method of claim 20, further comprising:
bidding down a price associated with the at least one of a product and a service.

26. The method of claim 20, further comprising:
accepting a submitted bid;
generating an online order for the at least one of a product and a service; and
generating an online payment transaction associated with the online order.

27. The method of claim 3, wherein the type of pet is selected from a group comprising dogs, cats, birds, horses, farm animals, exotic pets, reptiles, small animals, and fishes.

28. The method of claim 3, wherein the at least one of a product and a service is selected from a group comprising a food, a grooming product, a health product, a grooming service, an exercising service, a boarding service, and a care service.

29. The method of claim 1, further comprising:
simultaneously generating, in the three-dimensional map view, wiki profiles associated with specific geographic locations.

30. The method of claim 29, further comprising:
generating content associated with the wiki profiles.

31. The method of claim 1 in a form of a machine-readable medium embodying a set of instructions that, when executed by a machine, causes the machine to perform the method of claim 1.

32. A system, comprising:
a geo-spatial environment;
a data procurement module of the geo-spatial environment to procure preseeded pet data;
a category module of the geo-spatial environment to provide categories of the preseeded pet data;
a community network module of the geo-spatial environment, to include user profiles, each user profile of the user profiles associated with a specific geographic location and at least a portion of the preseeded pet data, and pet profiles, each pet profile associated with a user profile of the user profiles and the at least a portion of the preseeded pet data;
a map module of the geo-spatial environment to include map data of the specific geographic locations associated with each user profile of the user profiles;
a group module of the geo-spatial environment to generate groups of user profiles, each group based on at least one category of the categories of the preseeded pet data;
a display module of the geo-spatial environment to generate a display view of a three-dimensional map view embodied by a community network, at least a portion of the user profiles represented at locations in the three-dimensional map view corresponding with the specific geographic locations of the at least a portion of the user profiles and the pet profiles associated with the at least a portion of the user profiles; and
a communication module of the geo-spatial environment to generate a communication associated with at least one user profile of the user profiles.

33. The system of claim 32, wherein the preseeded pet data is procured from a public source.

34. The system of claim 33, further comprising:
a visualization module of the geo-spatial environment to determine a geographic region, to select at least one other category of the categories of the preseeded pet data, and to automatically generate, in the display view, a group of user profiles wherein each specific geographic location of each user profile of the group of user profiles is associated with the geographic region of the geographic regions and the at least one other category of the categories of the preseeded pet data is associated with each user profile of the group of user profiles.

35. The system of claim 34, wherein the geographic region is selected from a group comprising a neighborhood associated with a street address, a city, a county, a state, and a country.

36. The system of claim 31, further comprising:
a group formation module of the geo-spatial environment to enable formation of a group based on user profiles associated with at least one category of the categories of the preseeded pet data.

37. The system of claim 36, wherein the at least one category comprises a type of pet and at least one of a product and a service.

38. The system of claim 37, further comprising:
a pet club module of the geo-spatial environment to enable formation of a pet club group associated with at least one type of pet.

39. The system of claim 38, further comprising:
a meeting module of the geo-spatial environment to schedule meetings associated with the pet club group and to generate meeting notifications associated with the meetings.

40. The system of claim 36, further comprising:
a buyers club group module of the geo-spatial environment to enable formation of a buyers club group based on at least one of a product and a service.

41. The system of claim 40, further comprising:
a buyer transaction module of the geo-spatial environment to generate a business transaction associated with the buyers group.

42. The system of claim 41, wherein the business transaction comprises a bulk purchase transaction of the at least one of a product and a service.

43. The system of claim 42, wherein the bulk purchase transaction comprises an online purchase transaction.

44. The system of claim 37, further comprising:
a business module of the geo-spatial environment to enable formation of a business group based on at least one of at least one category of the preseeded pet data and at least one buyers club group.

45. The system of claim 44, further comprising:
a marketing module of the geo-spatial environment to generate a consumer communication via a communication mode to each user profile in a group of user profiles.

46. The system of claim 45, wherein the consumer communication is selected from a group comprising a marketing brochure, a flyer, a coupon, and a frequent shopper offer.

47. The system of claim 45, wherein the communication mode is selected from a group comprising an online communication mode and a physical communication mode.

48. The system of claim 37, further comprising:
a bidding module of the geo-spatial environment to identify a buyers club group and to generate a bid transaction associated with at least one of a product and a service.

49. The system of claim 48, wherein the bid transaction is selected from a group comprising a bid transaction to bid up, a bid transaction to bid down, a bid transaction to place a zero bid, a bid transaction to set a reserve price, a bid transaction to generate a request for bid, and a bid transaction to accept a submitted bid.

50. The system of claim 37, wherein the type of pet is selected from a group comprising dogs, cats, birds, horses, farm animals, exotic pets, reptiles, small animals, and fish.

51. The system of claim 37, wherein the at least one of a product and a service is selected from a group comprising a food, a grooming product, a health product, a grooming service, an exercising service, a boarding service, and a care service.

52. The system of claim 32 further comprising:
a wiki profile module of the geo-spatial environment to generate a wiki profile associated with at least one representation of a user profile.

53. The system of claim 52, comprising:
an append module of the geo-spatial environment to generate, with the at least one wiki profile, content associated with the at least one wiki profile.

54. The system of claim 31, further comprising:
a search module to generate a search associated with least one of the user profiles and the pet profiles based on at least one category of the categories of the preseeded pet data.

55. A geo-spatial environment, comprising:
a first instruction set to enable a community network, to include a map database associated with map data, a user database associated with user profiles, each user profile of the user profiles associated with a specific geographic location identifiable in the map data, and a pet database associated with preseeded pet data and pet profiles, each pet profile associated with a user profile of the user profiles;
a second instruction set integrated with the first instruction set to generate groups of user profiles, each group of the groups based on at least one category of the categories of the preseeded pet data; and
a third instruction set integrated with the first instruction and the second instruction set to display a three-dimensional map view, embodied by the community network, to include representations of a first group of the user profiles and the pet profiles associated with the first group of the user profiles, wherein each representation of a user profile of the first group of user profiles is displayed at a location in the three-dimensional dimensional map view corresponding to the specific geographic location associated with the user profile.

56. The geo-spatial environment of claim 55, further comprising:
a fourth instruction set to display, in the three-dimensional map view, a representation of a pet club group of user profiles based on a type of pet.

57. The geo-spatial environment of claim 55, further comprising:
a fifth instruction set to display in the three-dimensional map view, a representation of a buyers club group of user profiles associated with at least one of a product and a service.

58. The geo-spatial environment of claim 56, further comprising:
a sixth instruction set to display in the three-dimensional map view, a representation of a business group associated with the at least one of a product and a service.
